(19) United States
(12) Patent Application Publication
(10) Pub. No.: US 2024/0034845 A1
(43) Pub. Date: Feb. 1, 2024

(54) POLYMER PARTICLES

(71) Applicant: QUEENSLAND UNIVERSITY OF TECHNOLOGY, BRISBANE (AU)

(72) Inventors: Christopher Winfried Barner-Kowollik, GAYTHORNE (AU); Florian Feist, KARLSRUHE (DE); Jordan Peter Hooker, CLAYTON (AU); Laura Marie-claude Delafresnaye, HOLLAND PARK WEST (AU)

(73) Assignee: QUEENSLAND UNIVERSITY OF TECHNOLOGY, BRISBANE, QL (AU)

(21) Appl. No.: 18/248,202

(22) PCT Filed: Oct. 7, 2021
(86) PCT No.: PCT/AU2021/051170

§ 371 Date: Apr. 6, 2023

(30) Foreign Application Priority Data
Oct. 7, 2020 (AU) 2020903632

(51) Int. Cl. C08J 3/14; C08G 61/12

(52) U.S. Cl. CPC C08J 3/14; C08G 61/124; C08G 2261/46; C08G 2261/124; C08G 2261/1412; C08G 2261/1424; C08G 2261/312; C08G 2261/3221; C08G 2261/228; C08J 2465/00

(57) ABSTRACT

The present invention provides a method of producing polymer particles by precipitation polymerisation, the method comprising: providing a reaction solution comprising (i) solvent, (ii) a photo-active compound that upon being subjected to a wavelength of light forms two o-quinodimethane structures, and (iii) a multi-dienophile compound; subjecting the reaction solution to the wavelength of light, which promotes step-growth Diels-Alder polymerisation of the photo-active and multi-dienophile compounds; wherein as a result of the step-growth Diels-Alder polymerisation polymer precipitates from the reaction solution and self-assembles into the polymer particles.

### FIELD OF THE INVENTION

The present invention relates generally to polymer particles. In particular, the invention relates to a method of producing polymer particles.

### BACKGROUND OF THE INVENTION

Polymer particles are used in a diverse range of applications ranging from biomedical procedures to industrial coatings.

Polymer per se can be produced by many different polymerisation techniques/mechanisms using a vast array of different monomers. Irrespective of the technique/mechanism or monomers used, the physical form of the polymer produced is often an important consideration. Perhaps the most simple and basic form of polymerisation results in the formation of a polymer mass that takes on the physical form of the reaction vessel within which it is made.

For many applications it is particularly desirable, or even required, to present the polymer in particulate form, for example as substantially spherical particles.

Techniques for converting a pre-formed polymer mass into polymer particles have been developed. Such techniques include solubilising the pre-formed polymer, for example by dissolving it in solvent or by melt processing, and subsequently converting that liquid form of the polymer into a desired particle size and shape. However, such techniques include multiple steps, are often limited in process control and exclude the use of polymers that have been crosslinked.

It can be more efficient/effective to polymerise monomer to produce polymer directly in the form of polymer particles rather than convert pre-formed polymer into polymer particles. Considerable research in polymer science over many years has given rise to various polymerisation techniques for doing just that. For example, polymer particles are now commonly produced using emulsion or suspension polymerisation techniques. Such polymerisation techniques are quite efficient/effective in producing polymer particles with good reproducibility and control.

However, emulsion and suspension polymerisation techniques inherently require relatively complex process control and the use of process additives to efficiently and effectively produce polymer particles. For example, process control parameters such as reagent feed rate, stirring speed, and temperature typically need to be carefully adjusted and monitored. The process additives typically used, for example stabilisers/emulsifiers and initiators, carry over to the final polymer product and often present as an undesirable contaminant.

Emulsion and suspension polymerisation techniques also predominantly operate using free radical polymerisation chemistry. Such chemistry inherently affords relatively harsh reaction conditions that can adversely react with sensitive species, for example a bioactive agent, one might wish to incorporate into the polymer particle at the time of its production.

Accordingly, there remains an opportunity to develop methodology for producing polymer particles that address or ameliorate one or more of the problems associated with prior art methodology for producing polymer particles or at least provides a useful alternative.

### SUMMARY OF THE INVENTION

The present invention provides a method of producing polymer particles by precipitation polymerisation, the method comprising:
providing a reaction solution comprising (i) solvent, (ii) a photo-active compound that upon being subjected to a wavelength of light forms two o-quinodimethane structures, and (iii) a multi-dienophile compound;
subjecting the reaction solution to the wavelength of light, which promotes step-growth Diels-Alder polymerisation of the photo-active and multi-dienophile compound;
wherein as a result of the step-growth Diels-Alder polymerisation polymer precipitates from the reaction solution and self-assembles into the polymer particles.

It has surprisingly now been found polymer particles can be effectively and efficiently produced directly via precipitation Diels-Alder polymerisation. According to the present invention, the defined photo-active compound reacts with a multi-dienophile compound according to a step-growth Diels-Alder polymerisation to form polymer. The so formed polymer precipitates from the reaction solution and surprisingly self-assembles into polymer particles, such as substantially spherical polymer particles. The size of the polymer particles produced can advantageously be tailored in size to range from nanoparticles through to microparticles.

The method of the invention can be performed at room temperature and requires little or no process additives. The Diels-Alder polymerisation chemistry employed affords relatively mild reaction conditions that has little or no adverse effect on sensitive species, for example a bioactive agent, one might wish to incorporate into the polymer particle at the time of its production.

The method in accordance with the invention is believed to represent a paradigm shift in the production of polymer particles.

In one embodiment, the photo-active compound used has a general structure (I):

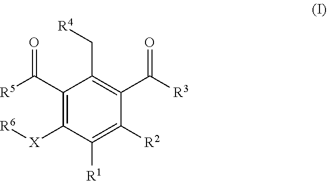

where R¹ is selected from H, halogen, CN, optionally substituted alkoxy, optionally substituted alkylthio, and saturated or unsaturated optionally substituted C₁₋₂₃-alkyl;
R² is selected from H, halogen, CN, optionally substituted alkoxy, optionally substituted alkylthio, and saturated or unsaturated optionally substituted C₁₋₂₃-alkyl;
R³ is selected from H, CN, saturated or unsaturated optionally substituted C₁₋₂₃-alkyl, optionally substituted aryl and optionally substituted heteroaryl;
R⁴ is selected from H, halogen, CN, optionally substituted alkoxy, optionally substituted alkylthio, and saturated or unsaturated optionally substituted C₁₋₂₃-alkyl;
R⁵ is selected from H, CN, saturated or unsaturated optionally substituted C₁₋₂₃-alkyl, optionally substituted aryl and optionally substituted heteroaryl;
R⁶ is selected from saturated or unsaturated optionally substituted C₁₋₂₃-alkyl, optionally substituted aryl, optionally substituted heteroaryl and SiR₃ where R is selected from optionally substituted C₁₋₂₃-alkyl, optionally substituted aryl and heteroaryl; and X is oxygen or sulphur.

In another embodiment, the photo-active compound used has a general structure (II):

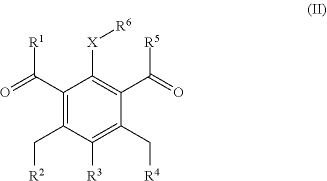

where R¹ is selected from H, CN, saturated or unsaturated optionally substituted C₁₋₂₃-alkyl, optionally substituted aryl and optionally substituted heteroaryl;
R² is selected from H, halogen, CN, optionally substituted alkoxy, optionally substituted alkylthio, and saturated or unsaturated optionally substituted C₁₋₂₃-alkyl;
R³ is selected from H, halogen, CN, optionally substituted alkoxy, optionally substituted alkylthio, and saturated or unsaturated optionally substituted C₁₋₂₃-alkyl;
R⁴ is selected from H, halogen, CN, optionally substituted alkoxy, optionally substituted alkylthio, and saturated or unsaturated optionally substituted C₁₋₂₃-alkyl;
R⁵ is selected from H, CN, saturated or unsaturated optionally substituted C₁₋₂₃-alkyl, optionally substituted aryl and optionally substituted heteroaryl;
R⁶ is selected from saturated or unsaturated, optionally substituted C₁₋₂₃-alkyl, optionally substituted aryl, optionally substituted heteroaryl and SiR₃ where R is selected from optionally substituted C₁₋₂₃-alkyl, optionally substituted aryl and heteroaryl; and
X is oxygen or sulphur.

In another embodiment, the photo-active compound used has a general structure (III):

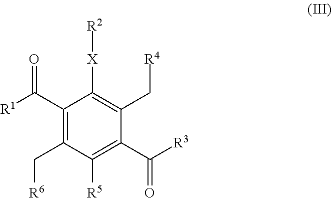

where R¹ is selected from H, CN, saturated or unsaturated optionally substituted C₁₋₂₃-alkyl, optionally substituted aryl and optionally substituted heteroaryl;
R² is selected from saturated or unsaturated optionally substituted C₁₋₂₃-alkyl, optionally substituted aryl, optionally substituted heteroaryl and SiR₃ where R is selected from optionally substituted C₁₋₂₃-alkyl, optionally substituted aryl and heteroaryl;
R³ is selected from H, CN, saturated or unsaturated optionally substituted C₁₋₂₃-alkyl, optionally substituted aryl and optionally substituted heteroaryl;
R⁴ is selected from H, halogen, CN, optionally substituted alkoxy, optionally substituted alkylthio, and saturated or unsaturated optionally substituted C₁₋₂₃-alkyl;
R⁵ is selected from H, halogen, CN, optionally substituted alkoxy, optionally substituted alkylthio, and saturated or unsaturated optionally substituted C₁₋₂₃-alkyl;
R⁶ is selected from H, halogen, CN, optionally substituted alkoxy, optionally substituted alkylthio, and saturated or unsaturated optionally substituted C₁₋₂₃-alkyl; and
X is oxygen or sulphur.

The polymer particles produced according to the method of the invention may have a cross-linked molecular structure.

In one embodiment, the reaction solution comprises a photo-active compound that upon being subjected to a wavelength of light forms 2ⁿ o-quinodimethane structures, where n is an integer ≥2.

In one embodiment, the multi-dienophile compound is a multi-maleimide compound.

The polymer particles produced in accordance with the method of the invention are believed to be unique in their own right. Accordingly, the present invention also provides polymer particles comprising Diels-Alder polymerised residues of (i) a photo-active compound that upon being subjected to a wavelength of light forms two o-quinodimethane structures and (ii) a multi-dienophile compound.

Further aspects and embodiments of the invention are discussed in more detail below.

### BRIEF DESCRIPTION OF DRAWINGS

Embodiments of the invention will now be described with reference to the following non-limiting drawings in which:

FIG. 1 shows a schematic of the bottle roller setup used for the synthesis of polymer particles in batch according to the present invention—see general procedure 1 in the Examples;

FIG. 2 shows polymer particles prepared in accordance with Example 7;

FIG. 3 shows polymer particles prepared in accordance with Example 8 of tunable diameter: #: 1 C=5 mmol L⁻¹. #2: C=1 mmol L⁻¹; #3: C=0.25 mmol L⁻¹;

FIG. 4 shows polymer particles prepared in accordance with Example 9 of tunable diameter: #1 C=5 mmol L⁻¹. #2: C=1.25 mmol L⁻¹;

FIG. 5 shows polymer particles prepared in accordance with Example 10 of tunable diameter: #1 C=5 mmol L⁻¹. #2: C=1.25 mmol L⁻¹;

FIG. 6 shows polymer particles prepared in accordance with Example 11 of tunable diameter: #: 1 C=5 mmol L⁻¹. #2: C=2.5 mmol L⁻¹; #3: C=0.5 mmol L⁻¹;

FIG. 7 shows polymer particles prepared in accordance with Example 12 of tunable diameter: #: 1 C=5 mmol L⁻¹. #2: C=2.5 mmol L⁻¹;

FIG. 8 shows cross-linked polymer particles prepared in accordance with Example 13;

FIG. 9 shows cross-linked polymer particles prepared in accordance with Example 14;

FIG. 10 shows polymer particles prepared in accordance with Example 15 with degradable backbone: #: 1 polymer spheres as synthesised. #2: polymer spheres after degradation using hydrogen peroxide; and

FIG. 11 shows polymer particles prepared using a flow reactor in accordance with Example 16.

### DESCRIPTION OF EMBODIMENTS

The present invention provides a method of producing polymer particles.

As used herein, the expression “polymer particles” is intended to mean a discrete mass of polymer that presents in particulate form.

While there is no particular limitation on the shape the polymer particles may take, they will generally be substantially spherical polymer particles.

The method of the invention may therefore also be described as producing substantially spherical polymer particles.

The method can advantageously be used to produce polymer particles of different sizes.

In one embodiment, the polymer particles comprise polymer microparticles.

In another embodiment, the polymer particles comprise polymer nanoparticles.

Reference herein to a microparticle is intended to mean particles having at least one dimension ranging from 100 nm to less than 1000 μm. The term “microparticle” is intended to embrace those particles in which all dimensions range from 100 nm to less than 1000 μm.

Reference herein to a “nanoparticle” is intended to mean a particle having at least one dimension less than 100 nm. The term “nanoparticle” is intended to embrace those particles in which all dimensions are less than 100 nm.

Where the polymer particles produced in accordance with the present invention are substantially spherical polymer particles it can be more convenient to reference the dimension of such particles in terms of the particles diameter.

In a further embodiment, the polymer particles are substantially spherical in shape and have an average diameter ranging from about 20 nm to about 20 μm, or about 30 nm to about 10 μm, or about 50 nm to about 5 μm.

The polymer particles produced in accordance with the invention may be porous (i.e. contain voids in the polymer matrix) or nonporous. Where the polymer particles are porous, the voids in the polymer matrix that form the porosity may contain a liquid or gas (e.g. air).

According to the method of the invention, the polymer particles are produced by precipitation polymerisation. By “precipitation polymerisation” is meant the monomer(s) used to form the polymer is soluble in a reaction solvent to form a reaction solution. Polymerisation proceeds in the reaction solution until the so formed polymer reaches a critical molecular weight that is insoluble in the reaction solution and causes the so formed polymer to precipitate from the reaction solvent. By definition, the method in accordance with the invention is therefore not an emulsion, suspension, solution or bulk polymerisation. According to the present invention, the so formed polymer precipitates from the reaction solution and surprisingly self-assembles into polymer particles, such as substantially spherical polymer particles.

The precipitation polymerisation may be conducted in batch, semicontinuous or continuous modes.

In one embodiment, the precipitation polymerisation is conducted in batch mode.

In another embodiment, the precipitation polymerisation is conducted in continuous mode

The reaction solution used in accordance with the invention comprises solvent. As those skilled in the art will appreciate, the role of such solvent is to provide a reaction medium within which the polymerisation is to occur. By performing a precipitation polymerisation, the solvent will be selected so as to suitably dissolve at least the monomers that polymerise to form the polymer.

There is no particular limitation on the type of solvent that may be used provided it can dissolve the monomers and can function as a reaction medium for the polymerisation reaction.

In one embodiment, the solvent is an aprotic solvent.

In a further embodiment, the solvent is a polar aprotic solvent.

A mixture of two or more different solvents may be used

Examples of suitable solvents include, but are not limited to, acetonitrile, benzonitrile, cyclohexanone, benzophenone, anisole, dimethyl sulfoxide, N,N-dimethyl formamide, dichloromethane, 1,4-dioxane and tetrahydrofuran.

In one embodiment, the solvent is selected from acetonitrile, benzonitrile, cyclohexanone, benzophenone, anisole, dimethyl sulfoxide, N,N-dimethyl formamide, dichloromethane, 1,4-dioxane and tetrahydrofuran and combinations thereof.

The reaction solution further comprises a photo-active compound. By being “photo-active” is meant that upon being exposed or subjected to a particular wavelength of light the compound undergoes a chemical rearrangement. In the context of the present invention, that chemical rearrangement is the formation of two o-quinodimethane structures. Accordingly, a photo-active compound used in accordance with invention is one that can form two o-quinodimethane structures upon being subjected to a particular wavelength of light.

o-Quinodimethanes (QDM's), also known as o-xylylenes, are highly reactive diene species generated form a precursor compound and have the following generalised (i.e. non-substituted) structure (A):

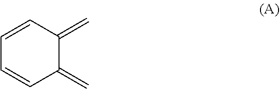

The generation of QDM's is well known in the art. In accordance with the method of the invention, two QDM's are generated from the photo-active compound.

When generated in the presence of a dienophile, QDM's are known to afford [4+2] cycloadducts, for example Diels-Alder adducts.

When generated in the absence of a suitable dienophile, QDM's are also known to afford [4+4]cycloadducts.

In the context of the present invention, the photo-active compound is used to generate two QDM's that undergo reaction with a multi-dienophile compound. That reaction proceeds by step growth Diels-Alder polymerisation to form a polymer product. As will be discussed in more detail below, the polymer product produced in accordance with the method of the invention is surprisingly in the form of polymer particles.

A photo-active compound suitable for use in accordance with the present invention may, upon being subjected to a wavelength of light, form more than two QDM's. As will be discussed in more detail below, photo-active compounds that generate more than two QDM's can introduce cross-linking into the polymer matrix that forms the polymer particles.

In one embodiment, the reaction solution comprises a combination of different photo-active compounds that each, upon being subjected to a wavelength of light, form two o-quinodimethane structures.

In another embodiment, the reaction solution comprises a combination of photo-active compounds that upon being subjected to a wavelength of light form (i) two o-quinodimethane structures, and (ii) greater than two o-quinodimethane structures.

In a further embodiment, the reaction solution comprises a combination of photo-active compounds that upon being subjected to a wavelength of light form (i) two o-quinodimethane structures, and (ii) 2ⁿ o-quinodimethane structures, where n is an integer ≥2. For example, and n may =2, 3 or 4.

Photo-active compounds that generate QDM's upon exposure to visible or UV light are known in the art and can advantageously be used in accordance with the invention.

The photo-active compound may have a general structure (I):

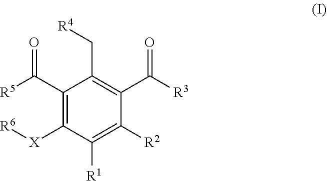

where R¹ is selected from H, halogen, CN, optionally substituted alkoxy, optionally substituted alkylthio, and saturated or unsaturated optionally substituted C₁₋₂₃-alkyl;
R² is selected from H, halogen, CN, optionally substituted alkoxy, optionally substituted alkylthio, and saturated or unsaturated optionally substituted C₁₋₂₃-alkyl;
R³ is selected from H, CN, saturated or unsaturated optionally substituted C₁₋₂₃-alkyl, optionally substituted aryl and optionally substituted heteroaryl;
R⁴ is selected from H, halogen, CN, optionally substituted alkoxy, optionally substituted alkylthio, and saturated or unsaturated optionally substituted C₁₋₂₃-alkyl;
R⁵ is selected from H, CN, saturated or unsaturated optionally substituted C₁₋₂₃-alkyl, optionally substituted aryl and optionally substituted heteroaryl;
R⁶ is selected from saturated or unsaturated optionally substituted C₁₋₂₃-alkyl, optionally substituted aryl, optionally substituted heteroaryl and SiR₃ where R is selected from optionally substituted C₁₋₂₃-alkyl, optionally substituted aryl and heteroaryl; and
X is oxygen or sulphur.

In one embodiment, the photo-active compound may have a general structure (Ia):

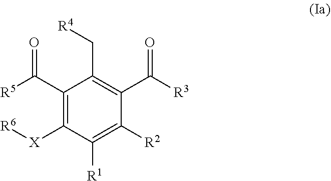

where R¹ is selected from H, CH₃ and Br;
R² is selected from H, CH₃ and Br;
R³ is H;
R⁴ is H;
R⁵ is H;
R⁶ is selected from C₁₋₂₃ alkyl; and
X is oxygen.

The photo-active compound may also have a general structure (II):

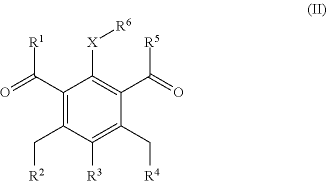

where R¹ is selected from H, CN, saturated or unsaturated optionally substituted C₁₋₂₃-alkyl, optionally substituted aryl and optionally substituted heteroaryl;
R² is selected from H, halogen, CN, optionally substituted alkoxy, optionally substituted alkylthio, and saturated or unsaturated optionally substituted C₁₋₂₃-alkyl;
R³ is selected from H, halogen, CN, optionally substituted alkoxy, optionally substituted alkylthio, and saturated or unsaturated optionally substituted C₁₋₂₃-alkyl;
R⁴ is selected from H, halogen, CN, optionally substituted alkoxy, optionally substituted alkylthio, and saturated or unsaturated optionally substituted C₁₋₂₃-alkyl;
R⁵ is selected from H, CN, saturated or unsaturated optionally substituted C₁₋₂₃-alkyl, optionally substituted aryl and optionally substituted heteroaryl;
R⁶ is selected from saturated or unsaturated, optionally substituted C₁₋₂₃-alkyl, optionally substituted aryl, optionally substituted heteroaryl and SiR₃ where R is selected from optionally substituted C₁₋₂₃-alkyl, optionally substituted aryl and heteroaryl; and
X is oxygen or sulphur.

In one embodiment, the photo-active compound may have a general structure (IIa):

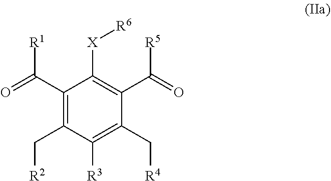

where R¹ is H;
R² is H;
R³ is H;
R⁴ is H;
R⁵ is H;
R⁶ is selected from C₁₋₂₃-alkyl; and
X is oxygen.

The photo-active compound may also have a general structure (III):

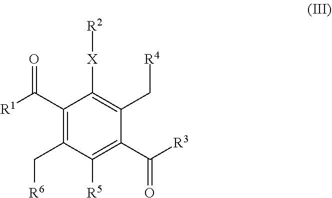

where R¹ is selected from H, CN, saturated or unsaturated optionally substituted C₁₋₂₃-alkyl, optionally substituted aryl and optionally substituted heteroaryl;
R² is selected from saturated or unsaturated optionally substituted C₁₋₂₃-alkyl, optionally substituted aryl optionally substituted heteroaryl SiR₃ where R is selected from optionally substituted C₁₋₂₃-alkyl, optionally substituted aryl, heteroaryl;
R³ is selected from H, CN, saturated or unsaturated optionally substituted C₁₋₂₃-alkyl, optionally substituted aryl and optionally substituted heteroaryl;
R⁴ is selected from H, halogen, CN, optionally substituted alkoxy, optionally substituted alkylthio, and saturated or unsaturated optionally substituted C₁₋₂₃-alkyl;
R⁵ is selected from H, halogen, CN, optionally substituted alkoxy, optionally substituted alkylthio, and saturated or unsaturated optionally substituted C₁₋₂₃-alkyl;
R⁶ is selected from H, halogen, CN, optionally substituted alkoxy, optionally substituted alkylthio, and saturated or unsaturated optionally substituted C₁₋₂₃-alkyl; and
X is oxygen or sulphur.

In one embodiment, the photo-active compound may have a general structure (IIIa):

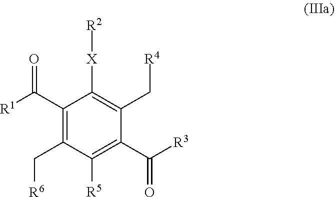

where R¹ is H;
R² is selected from C₁₋₂₃-alkyl;
R³ is H
R⁴ is H;
R⁵ is alkoxy (e.g. such as OR where R is optionally substituted C₁₋₂₃-alkyl);
R⁶H; and
X is oxygen.

The reaction solution may comprise a combination of different photo-active compounds that generate 2 or more QDM's. Photo-active compounds that generate more than 2 QDM's can introduce branching and/or cross-linking into the polymer matrix that forms the polymer particles.

In one embodiment, the reaction solution comprises a photo-active compound that upon being subjected to a wavelength of light forms four o-quinodimethane structures.

Examples of photo-active compounds suitable for use in accordance with the invention also include those of general structure (IV):

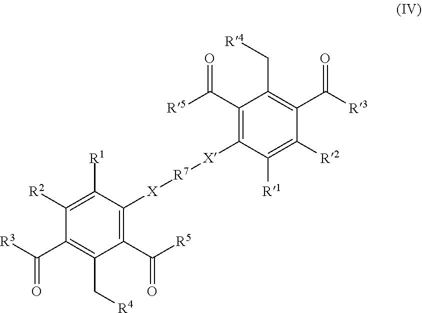

where R¹ and R^{′1} are each independently selected from H, halogen, CN, optionally substituted alkoxy, optionally substituted alkylthio, and saturated or unsaturated optionally substituted C₁₋₂₃-alkyl;
R² and R^{′2} are each independently selected from H, halogen, CN, optionally substituted alkoxy, optionally substituted alkylthio, and saturated or unsaturated optionally substituted C₁₋₂₃-alkyl;
R³ and R^{′3} are each independently selected from H, CN, saturated or unsaturated optionally substituted C₁₋₂₃-alkyl, optionally substituted aryl and optionally substituted heteroaryl;
R⁴ and R^{′4} are each independently selected from H, halogen, CN, optionally substituted alkoxy, optionally substituted alkylthio, and saturated or unsaturated optionally substituted C₁₋₂₃-alkyl;
R⁵ and R^{′s} are each independently selected from H, CN, saturated or unsaturated optionally substituted C₁₋₂₃-alkyl, optionally substituted aryl and optionally substituted heteroaryl;
R⁷ is selected from saturated or unsaturated, optionally substituted C₁₋₂₃-alkyl, optionally substituted aryl, optionally substituted heteroaryl and SiR₂ where R is selected from optionally substituted C₁₋₂₃-alkyl, optionally substituted aryl and heteroaryl; and
X and X′ are each independently oxygen or sulphur.

More specific examples of general structure (IV) include those of general structure (IVa):

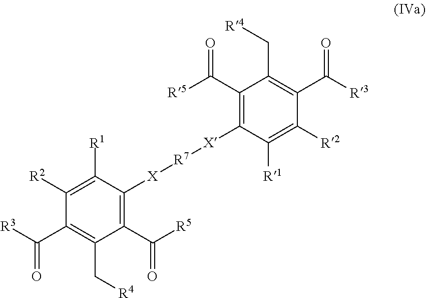

where R¹ and R^{′1} are each independently selected from H, CH₃ and Br;
R² and R^{′2} are each independently selected from H, CH₃ and Br;
R³ and R^{′3} are H;
R⁴ and R^{′4} are H;
R⁵ and R^{′5} are H;
R⁷ is selected from C₁₋₂₃-alkyl and aryl; and
X and X′ are oxygen.

Examples of photo-active compounds suitable for use in accordance with the invention further include those of general structure (V):

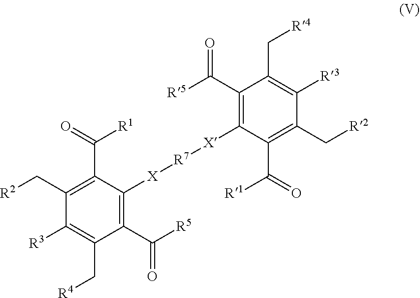

where R¹ and R^{′1} are each independently selected from H, CN, saturated or unsaturated optionally substituted C₁₋₂₃-alkyl, optionally substituted aryl and optionally substituted heteroaryl;
R² and R^{′2} are each independently selected from H, halogen, CN, optionally substituted alkoxy, optionally substituted alkylthio, and saturated or unsaturated optionally substituted C₁₋₂₃-alkyl;
R³ and R^{′3} are each independently selected from H, halogen, CN, optionally substituted alkoxy, optionally substituted alkylthio, and saturated or unsaturated optionally substituted C₁₋₂₃-alkyl;
R⁴ and R^{′4} are each independently selected from H, halogen, CN, optionally substituted alkoxy, optionally substituted alkylthio, and saturated or unsaturated optionally substituted C₁₋₂₃-alkyl;
R⁵ and R^{′5} are each independently selected from H, saturated or unsaturated optionally substituted C₁₋₂₃-alkyl, optionally substituted aryl and optionally substituted heteroaryl;
R⁷ is selected from saturated or unsaturated optionally substituted C₁₋₂₃-alkyl, optionally substituted aryl, optionally substituted heteroaryl and SiR₂ where R is selected from optionally substituted C₁₋₂₃-alkyl, optionally substituted aryl and heteroaryl; and
X and X′ are each independently oxygen or sulphur.

More specific examples of general structure (V) include those of general structure (Va):

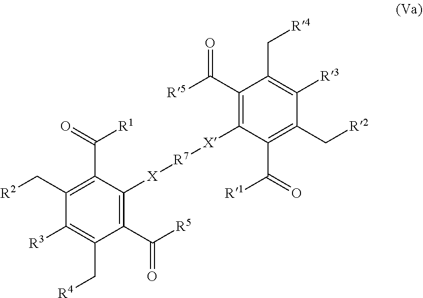

where R¹ and R^{′1} are H;
R² and R^{′2} are H;
R³ and R^{′3} are H;
R⁴ and R^{′4} are H;
R⁵ and R^{′5} are H;
R⁷ is selected from C₁₋₂₃-alkyl and aryl; and
X and X′ are oxygen.

The reaction solution will generally comprise about 0.001 mmol L⁻¹ to about 500 mmol L⁻¹ of the photo-active compound.

In one embodiment, the reaction solution comprises a mixture of photo-active compounds made up from (i) 1 wt. % to 99 wt % of a photo-active compound that upon being subjected to a wavelength of light forms only two o-quinodimethane structures, and (ii) 99 wt. % to 1 wt % of a photo-active compound that upon being subjected to a wavelength of light forms more than two o-quinodimethane structures, for example four o-quinodimethane structures.

Upon being subjected or exposed to a wavelength of light, the photo-active compounds used in accordance with the invention form or generate at least two o-quinodimethane structures. The mechanism by which such QDM's form is well known in the art, as to are techniques for generating a suitable wavelength of light and exposing the compounds to that light.

The particular wavelength of light required to generate the QDM's from the photo-active compounds can vary, but will typically range from about 300 nm to about 450 nm.

Those skilled in the art can readily determine the most appropriate wavelength of light to use in order to generate the QDM's from a given photoactive compound, for example by considering the absorption spectrum of the photoactive compound and its wavelength-dependent reactivity and selectivity.

The reaction solution further comprises a multi-dienophile compound. The term “dienophile” is intended to have the well-known meaning as used in the context of a Diels-Alder [4+2]cycloaddition reaction. By being a “multi-” dienophile compound is meant the compound contains 2 or more dienophile moieties.

Examples of multi-dienophiles include, but are not limited to, bis-dienophiles, tris-dienophiles, tetrakis-dienophiles and pentakis-dienophiles.

In one embodiment, the multi-dienophile compound is a multi-maleimides compound.

In a further embodiment, the multi-dienophile compound is selected from bis-maleimides, tris-maleimides, tetrakis-maleimides, pentakis-maleimides and combinations thereof.

The reaction solution may comprise a mixture of different multi-dienophile compounds.

Examples of suitable bis-maleimide compounds that may be used in accordance with the invention include, but are not limited to, those of general structures (VI), (VII) and (VIII):

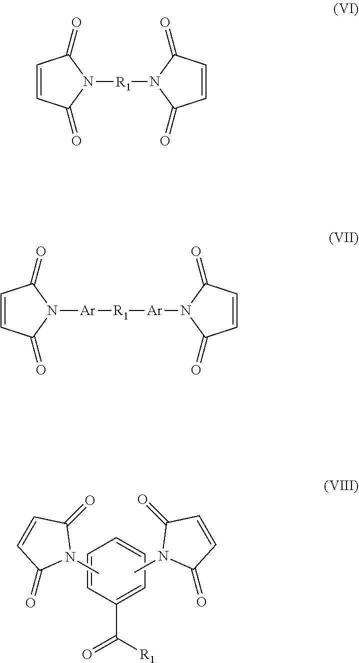

where for general structure (VI) R₁ is selected from optionally substituted aryl, optionally substituted alkyl and optionally substituted carbocyclyl; for general structure (VII) R₁ is selected from optionally substituted aryl, optionally substituted alkyl and optionally substituted carbocyclyl, and each Ar is independently optionally substituted aryl or heteroaryl, and for general structure (VIII) R₁ is selected from optionally substituted aryl, optionally substituted alkyl, optionally substituted carbocyclyl, and a linking group that couples one or more compounds of structure (VIII) through the R₁ substituent to structure (VIII), where the linking group is selected from optionally substituted aryl, optionally substituted alkyl and optionally substituted carbocyclyl.

Specific examples of suitable bis-maleimide compounds include, but are not limited to, N,N′-m/o/p-phenylene-bis-maleimide, N,N′-hexamethylene-bis-maleimide, N,N′-octamethylene-bis-maleimide, N,N′-4,4′-diphenylmethane-bis-maleimide, N,N′-ethylene-bis-maleimide, N,N′-butylene-bis-maleimide, N,N′-4,4′-diphenyl ether bis-maleimide: N,N′-4,4′diphenyl sulfone-bis-maleimide, N,N′-4,4′-dicyclohexyl methane-bis-maleimide, N,N′-xylylene-bis-maleimide, N,N′-diphenyl cyclohexane-bis-male imide, N,N′-(p-tolylene) bismaleimide, N,N′-(methylenedi-p-phenylene)-bismaleimide, N,N′-(oxydi-p-phenylene)bismaleimide, α,α-bis-(4-phenylene)-bismaleimide, N,N′-(m-xylylene) bis-citraconimide, α,α-bis-(4-maleimidophenyl)-meta-di isopropylbenzene, 2,4-bismaleimidotoluene, 4,4′-bis(o-propenylphenoxy)-benzophenone, 2,2′-bis(3-allyl-4-hydroxyphenyl)-propane and combinations thereof.

Specific examples of suitable tris-maleimide compounds include, but are not limited to, tris-(2-maleimidoethyl)amine, 1,3,5-benzene-tris-maleimide, 1,3,5 melamine-tris-maleimide and combinations thereof.

A specific example of where R₁ in general structure (VIII) is a linking group represented by optionally substituted alkyl that couples one compound of structure (VIII) through the R₁ substituent to structure (VIII) includes, but is not limited to, general structure (VIIIa):

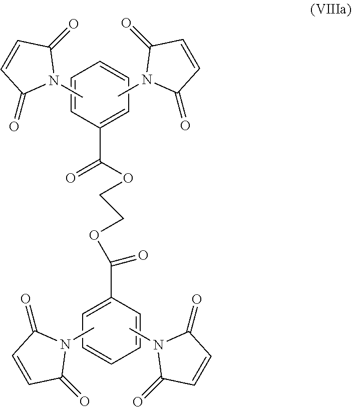

The reaction solution will generally comprise about 0.001 mmol L⁻¹ to about 500 mmol L⁻¹ of the multi-dienophile compound.

The mole ratio between the photoactive compound and the multi-dienophile compound will generally range from about 0.1:1 to about 10:1.

The size of the polymer particles can advantageously be adjusted by altering the concentration of the multi-dienophile compound and/or the photo-active compound, the type of solvent or solvent mixture, the reaction temperature, the radiant intensity at a given wavelength and the reagent stoichiometry. In addition, size and properties of the particles can be adjusted by the replacement of a photo-active compound that forms 2 QDMs with a photo-active compound that forms 2ⁿ (n>1) QDMs upon irradiation, from a ratio about 0.01% to 90%.

Conventional techniques for preparing polymer particles typically require the use of reaction media incorporating various process additives. For example, in addition to the monomers used to form the polymer, conventional emulsion and suspension polymerisation typically include initiator compounds, emulsifiers/surfactants and other process additives in their reaction media. The method in accordance with the present invention can advantageously be performed using a very simple reaction media that essentially only includes the monomers used to form the polymer. In particular, the polymerisation itself is initiated photo-chemically and therefore does not require an initiator compound to be incorporated in the reaction media. Also, which is particularly surprising, monomers present in the reaction solution polymerise to form polymer that precipitates to directly form the polymer particles without the need for using any emulsifiers/surfactants. Polymer particles prepared in accordance with the method of the invention can therefore advantageously be produced substantially free of any process additives. In addition, the polymer particle synthesis proceeds under mild reaction conditions, without the involvement of highly reactive radical species. The method according to the present invention is therefore well suited for incorporating into the polymer particles molecules having sensitive functional groups (i.e sensitive in the sense they would adversely react in the present of radical species—e.g. bioactive molecules).

In one embodiment, the reaction solution does not comprise an initiator compound.

In another embodiment, the reaction solution does not comprise an emulsifier or surfactant.

While the method of the invention can be performed to produce polymer particles without the need for using conventional process additives, it nevertheless remains possible to include additional reagents in the reaction solution when preparing the polymer particles.

For example, the reaction solution might further comprise application specific compounds for encapsulation such as fluorophores or bioactive agents, being previously functionalised with suitable functional groups allowing for the incorporation into the particles or on the particle surfaces. The application specific compounds might be added at any time during the particle formation procedure or after the particle formation procedure.

In one embodiment, the reaction solution comprises a fluorophore or a bioactive agent.

The method according to the present invention also advantageously can be performed using simple processing conditions. For example, the polymerisation can proceed at room temperature or higher temperatures. The reaction solution presents as a stable, homogeneous solution which only reacts upon irradiation. Such photochemical reaction initiation allows for an external, substantially instantaneous on-off switch that affords excellent reaction control. The polymer particles typically form in a continuous process without active stirring of the reaction solution, and do not need to be stabilised or prepared initially as a heterogeneous mixture.

According to the method of the invention, the reaction solution is subjected (i.e. exposed) to a wavelength of light that promotes step-growth Diels-Alder polymerisation of the photo-active and multi-dienophile compounds.

Subjecting the reaction solution to the required wavelength(s) of light can be achieved using techniques well-known in the art. For example, that will typically be achieved in practice by using LEDs or fluorescent light bulbs.

The wavelength of light will generally be applied to the reaction solution at an irradiance ranging from about 0.025-5 W cm².

In one embodiment, the reaction solution is subject to a substantially homogeneous wavelength of light.

Upon subjecting the reaction solution to the wavelength of light, the photo-active compound forms the required two QDM's in the presence of the multi-dienophile compound, which in turn promotes the step-growth Diels-Alder polymerisation. That Diels-Alder polymerisation mechanism is believed to proceed conventionally as understood in the art.

However, unlike conventional Diels-Alder polymerisations, that which occurs in accordance with the present invention produces polymer that precipitates from the reaction solution and directly self-assembles into polymer particles.

It is not entirely clear why polymer produced in accordance with the invention precipitates from the reaction solution and self-assembles into polymer particles. Without wishing to be limited by theory, it is believed rapid reaction kinetics that occurs between the specific QDM's generated and the multi-dienophile compound may play a role in the unique polymer particle formation. As polymer is formed it gradually precipitates from solution by a desolvation process to form growing nuclei. Those growing nuclei appear to become self-stabilised allowing them to grow into the polymer particles.

The overall procedure for performing the method of the invention is relatively straightforward and makes use of general techniques and equipment known in the art.

The method of the invention may be performed in batch mode. For example, the photo-active and multi-dienophile compounds may be combined with a suitable solvent to form the homogeneous reaction solution. The homogeneous reaction solution can be filtered to remove seed particles (dust) and optionally degassed by passing through a steam of nitrogen and then added to a reaction vessel. The reaction solution may be agitated, for instance using a bottle roller while being irradiated with a suitable wavelength and intensity of light—typically at ambient temperature. Following the polymerisation reaction the so formed polymer particles can be collected by centrifugation and/or filtration and washed.

Alternatively, the method of the invention may be performed in continuous mode. For example, the polymerisation may be conducted in a continuous flow reactor. In that case, the photo-active and multi-dienophile compounds may be combined with a suitable solvent, filtered and optionally degassed by passing through a stream of nitrogen. Afterwards the reaction solution can be passed through a flow reactor while being irradiated with a suitable wavelength and intensity of light—typically at ambient temperature. The reactor eluent comprising the so formed polymer particles can be collected and the polymer particles isolated by centrifugation and washed.

In one embodiment, the polymer particles are produced in a flow reactor.

In one embodiment, the reaction solution is provided in a continuous flow reactor and the polymer particles are prepared continuously.

In a further embodiment, the continuous flow reactor comprises one or more flow-lines through which the reaction solution flows.

The polymer particles according to the invention comprise Diels-Alder polymerised residues of (i) a photo-active compound that upon being subjected to a wavelength of light forms two o-quinodimethane structures and (ii) a multi-dienophile compound.

By the polymer particles comprising Diels-Alder “polymerised residues” of the photoactive compound and multi-dienophile compound is meant the polymer matrix of the polymer particles is made up from the Diels-Alder polymerisation reaction product formed between the photoactive compound and the multi-dienophile compound. Those skilled in the art will appreciate the molecular structure of such a reaction product is complex and cannot be readily described per se.

Having said that, it is common in the art to refer to a Diels-Alder reaction product as a Diels-Alder adduct. On that basis, the present invention may also be said to provide polymer particles comprising Diels-Alder polymerisation adduct of a (i) photo-active compound that upon being subjected to a wavelength of light forms two o-quinodimethane structures, and (ii) multi-dienophile compound.

The photoactive compound and multi-dienophile compound include those as described herein.

The shape and size of the polymer particles are as described herein.

In one embodiment, the polymer particles according to the present invention are in the form of substantially spherical polymer nanoparticles.

In another embodiment, the polymer particles according to the present invention are in the form of substantially spherical polymer microparticles.

The polymer particles in accordance with the invention may be used in a diverse range of applications, including, but not limited to, biomedical, industrial coating and analytical applications.

As used herein, the term “alkyl”, used either alone or in compound words denotes straight chain, branched or cyclic alkyl, for example C₁₋₄₀ alkyl, or C₁₋₂₀ or C₁₋₁₀. Examples of straight chain and branched alkyl include methyl, ethyl, n-propyl, isopropyl, n-butyl, sec-butyl, t-butyl, n-pentyl, 1,2-dimethylpropyl, 1,1-dimethyl-propyl, hexyl, 4-methylpentyl, 1-methylpentyl, 2-methylpentyl, 3-methylpentyl, 1,1-dimethylbutyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, heptyl, 5-methylhexyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethyl-pentyl, 1,2,3-trimethylbutyl, 1,1,2-trimethylbutyl, 1,1,3-trimethylbutyl, octyl, 6-methylheptyl, 1-methylheptyl, 1,1,3,3-tetramethylbutyl, nonyl, 1-, 2-, 3-, 4-, 5-, 6- or 7-methyloctyl, 1-, 2-, 3-, 4- or 5-ethylheptyl, 1-, 2- or 3-propylhexyl, decyl, 1-, 2-, 3-, 4-, 5-, 6-, 7- and 8-methylnonyl, 1-, 2-, 3-, 4-, 5- or 6-ethyloctyl, 1-, 2-, 3- or 4-propylheptyl, undecyl, 1-, 2-, 3-, 4-, 5-, 6-, 7-, 8- or 9-methyldecyl, 1-, 2-, 3-, 4-, 5-, 6- or 7-ethylnonyl, 1-, 2-, 3-, 4- or 5-propyloctyl, 1-, 2- or 3-butylheptyl, 1-pentylhexyl, dodecyl, 1-, 2-, 3-, 4-, 5-, 6-, 7-, 8-, 9- or 10-methylundecyl, 1-, 2-, 3-, 4-, 5-, 6-, 7- or 8-ethyldecyl, 1-, 2-, 3-, 4-, 5- or 6-propylnonyl, 1-, 2-, 3- or 4-butyloctyl, 1-2-pentylheptyl, tridecyl, tetradecyl, pentadecyl, hexadecyl, heptadecyl, octadecyl, nonoadecyl, eicosyl and the like. Examples of cyclic alkyl include mono- or polycyclic alkyl groups such as cyclopropyl, cyclobutyl, cyclopentyl, cyclohexyl, cycloheptyl, cyclooctyl, cyclononyl, cyclodecyl and the like. Where an alkyl group is referred to generally as “propyl”, butyl” etc, it will be understood that this can refer to any of straight, branched and cyclic isomers where appropriate. An alkyl group may be optionally substituted by one or more optional substituents as herein defined.

In this specification “optionally substituted” is taken to mean that a group may or may not be substituted or fused (so as to form a condensed polycyclic group) with one, two, three or more of organic and inorganic groups (i.e. the optional substituent) including those selected from: alkyl, alkenyl, alkynyl, carbocyclyl, aryl, heterocyclyl, heteroaryl, acyl, aralkyl, alkaryl, alkheterocyclyl, alkheteroaryl, alkcarbocyclyl, halo, haloalkyl, haloalkenyl, haloalkynyl, haloaryl, halocarbocyclyl, haloheterocyclyl, haloheteroaryl, haloacyl, haloaryalkyl, hydroxy, hydroxyalkyl, hydroxyalkenyl, hydroxyalkynyl, hydroxycarbocyclyl, hydroxyaryl, hydroxyheterocyclyl, hydroxyheteroaryl, hydroxyacyl, hydroxyaralkyl, alkoxyalkyl, alkoxyalkenyl, alkoxyalkynyl, alkoxycarbocyclyl, alkoxyaryl, alkoxyheterocyclyl, alkoxyheteroaryl, alkoxyacyl, alkoxyaralkyl, alkoxy, alkenyloxy, alkynyloxy, aryloxy, carbocyclyloxy, aralkyloxy, heteroaryloxy, heterocyclyloxy, acyloxy, haloalkoxy, haloalkenyloxy, haloalkynyloxy, haloaryloxy, halocarbocyclyloxy, haloaralkyloxy, haloheteroaryloxy, haloheterocyclyloxy, haloacyloxy, nitro, nitroalkyl, nitroalkenyl, nitroalkynyl, nitroaryl, nitroheterocyclyl, nitroheteroayl, nitrocarbocyclyl, nitroacyl, nitroaralkyl, amino (NH₂), alkylamino, dialkylamino, alkenylamino, alkynylamino, arylamino, diarylamino, aralkylamino, diaralkylamino, acylamino, diacylamino, heterocyclamino, heteroarylamino, carboxy, carboxyester, amido, alkylsulphonyloxy, arylsulphenyloxy, alkylsulphenyl, arylsulphenyl, thio, alkylthio, alkenylthio, alkynylthio, arylthio, aralkylthio, carbocyclylthio, heterocyclylthio, heteroarylthio, acylthio, sulfoxide, sulfonyl, sulfonamide, aminoalkyl, aminoalkenyl, aminoalkynyl, aminocarbocyclyl, aminoaryl, aminoheterocyclyl, aminoheteroaryl, aminoacyl, aminoaralkyl, thioalkyl, thioalkenyl, thioalkynyl, thiocarbocyclyl, thioaryl, thioheterocyclyl, thioheteroaryl, thioacyl, thioaralkyl, carboxyalkyl, carboxyalkenyl, carboxyalkynyl, carboxycarbocyclyl, carboxyaryl, carboxyheterocyclyl, carboxyheteroaryl, carboxyacyl, carboxyaralkyl, carboxyesteralkyl, carboxyesteralkenyl, carboxyesteralkynyl, carboxyestercarbocyclyl, carboxyesteraryl, carboxyesterheterocyclyl, carboxyesterheteroaryl, carboxyesteracyl, carboxyesteraralkyl, amidoalkyl, amidoalkenyl, amidoalkynyl, amidocarbocyclyl, amidoaryl, amidoheterocyclyl, amidoheteroaryl, amidoacyl, amidoaralkyl, formylalkyl, formylalkenyl, formylalkynyl, formylcarbocyclyl, formylaryl, formylheterocyclyl, formylheteroaryl, formylacyl, formylaralkyl, acylalkyl, acylalkenyl, acylalkynyl, acylcarbocyclyl, acylaryl, acylheterocyclyl, acylheteroaryl, acylacyl, acylaralkyl, sulfoxidealkyl, sulfoxidealkenyl, sulfoxidealkynyl, sulfoxidecarbocyclyl, sulfoxidearyl, sulfoxideheterocyclyl, sulfoxideheteroaryl, sulfoxideacyl, sulfoxidearalkyl, sulfonylalkyl, sulfonylalkenyl, sulfonylalkynyl, sulfonylcarbocyclyl, sulfonylaryl, sulfonylheterocyclyl, sulfonylheteroaryl, sulfonylacyl, sulfonylaralkyl, sulfonamidoalkyl, sulfonamidoalkenyl, sulfonamidoalkynyl, sulfonamidocarbocyclyl, sulfonamidoaryl, sulfonamidoheterocyclyl, sulfonamidoheteroaryl, sulfonamidoacyl, sulfonamidoaralkyl, nitroalkyl, nitroalkenyl, nitroalkynyl, nitrocarbocyclyl, nitroaryl, nitroheterocyclyl, nitroheteroaryl, nitroacyl, nitroaralkyl, cyano, sulfate and phosphate groups. “Optionally substituted” may also be taken to refer to a situation where a —CH₂— group in a chain or ring (e.g. alkyl or aryl) is replaced by a group selected from —O—, —S—, —NR^{A}—, —C(O)— (i.e. carbonyl), —C(O)O— (i.e. ester), and —C(O)NR^{A}— (i.e. amide), where R^{A} is as defined herein (see amino and amido).

Optional substituents may include alkyl (e.g. C₁₋₆ alkyl such as methyl, ethyl, propyl, butyl, cyclopropyl, cyclobutyl, cyclopentyl or cyclohexyl), hydroxyalkyl (e.g. hydroxymethyl, hydroxyethyl, hydroxypropyl), alkoxyalkyl (e.g. methoxymethyl, methoxyethyl, methoxypropyl, ethoxymethyl, ethoxyethyl, ethoxypropyl etc) alkoxy (e.g. C₁₋₆ alkoxy such as methoxy, ethoxy, propoxy, butoxy, cyclopropoxy, cyclobutoxy), halo, trifluoromethyl, trichloromethyl, tribromomethyl, hydroxy, phenyl (which itself may be further substituted e.g., by C₁₋₆ alkyl, halo, hydroxy, hydroxyC₁₋₆alkyl, C₁₋₆alkoxy, haloC₁₋₆alkyl, cyano, nitro OC(O)C₁₋₆alkyl, and amino), benzyl (wherein benzyl itself may be further substituted e.g., by C₁₋₆ alkyl, halo, hydroxy, hydroxyC₁₋₆alkyl, C₁₋₆alkoxy, haloC₁₋₆alkyl, cyano, nitro OC(O)C₁₋₆alkyl, and amino), phenoxy (wherein phenyl itself may be further substituted e.g., by C₁₋₆ alkyl, halo, hydroxy, hydroxyC₁₋₆ alkyl, C₁₋₆ alkoxy, haloC₁₋₆ alkyl, cyano, nitro OC(O)C₁₋₆ alkyl, and amino), benzyloxy (wherein benzyl itself may be further substituted e.g., by C₁₋₆ alkyl, halo, hydroxy, hydroxyC₁₋₆ alkyl, C₁₋₆ alkoxy, haloC₁₋₆ alkyl, cyano, nitro OC(O)C₁₋₆ alkyl, and amino), amino, alkylamino (e.g. C₁₋₆ alkyl, such as methylamino, ethylamino, propylamino etc), dialkylamino (e.g. C₁₋₆ alkyl, such as dimethylamino, diethylamino, dipropylamino), acylamino (e.g. NHC(O)CH₃), phenylamino (wherein phenyl itself may be further substituted e.g., by C₁₋₆alkyl, halo, hydroxy hydroxyC₁₋₆ alkyl, C₁₋₆ alkoxy, haloC₁₋₆ alkyl, cyano, nitro OC(O)C₁₋₆alkyl, and amino), nitro, formyl, —C(O)— alkyl (e.g. C₁₋₆ alkyl, such as acetyl), O—C(O)-alkyl (e.g. C₁₋₆alkyl, such as acetyloxy), benzoyl (wherein the phenyl group itself may be further substituted e.g., by C₁₋₆ alkyl, halo, hydroxy hydroxyC₁₋₆ alkyl, C₁₋₆ alkoxy, haloC₁₋₆ alkyl, cyano, nitro OC(O)C₁₋₆ alkyl, and amino), replacement of CH₂ with C═O, CO₂H, CO₂alkyl (e.g. C₁₋₆ alkyl such as methyl ester, ethyl ester, propyl ester, butyl ester), CO₂phenyl (wherein phenyl itself may be further substituted e.g., by C₁₋₆ alkyl, halo, hydroxy, hydroxyl C₁₋₆ alkyl, C₁₋₆ alkoxy, halo C₁₋₆ alkyl, cyano, nitro OC(O)C₁₋₆ alkyl, and amino), CONH₂, CONHphenyl (wherein phenyl itself may be further substituted e.g., by C₁₋₆ alkyl, halo, hydroxy, hydroxyl C₁₋₆ alkyl, C₁₋₆ alkoxy, halo C₁₋₆ alkyl, cyano, nitro OC(O)C₁₋₆ alkyl, and amino), CONHbenzyl (wherein benzyl itself may be further substituted e.g., by C₁₋₆ alkyl, halo, hydroxy hydroxyl C₁₋₆ alkyl, C₁₋₆ alkoxy, halo C₁₋₆ alkyl, cyano, nitro OC(O)C₁₋₆ alkyl, and amino), CONHalkyl (e.g. C₁₋₆ alkyl such as methyl ester, ethyl ester, propyl ester, butyl amide) CONHdialkyl (e.g. C₁₋₆ alkyl) aminoalkyl (e.g., HN C₁₋₆ alkyl-, C₁₋₆alkylHN-C₁₋₆ alkyl- and (C₁₋₆ alkyl)₂N—C₁₋₆ alkyl-), thioalkyl (e.g., HS C₁₋₆alkyl-), carboxyalkyl (e.g., HO₂CC₁₋₆alkyl-), carboxyesteralkyl (e.g., C₁₋₆ alkylO₂CC₁₋₆ alkyl-), amidoalkyl (e.g., H₂N(O)CC₁₋₆ alkyl-, H(C₁₋₆ alkyl)N(O)CC₁₋₆ alkyl-), formylalkyl (e.g., OHCC₁₋₆alkyl-), acylalkyl (e.g., C₁₋₆ alkyl(O)CC₁₋₆ alkyl-), nitroalkyl (e.g., O₂NC₁₋₆ alkyl-), sulfoxidealkyl (e.g., R³(O)SC₁₋₆ alkyl, such as C₁₋₆ alkyl(O)SC₁₋₆ alkyl-), sulfonylalkyl (e.g., R³(O)₂SC₁₋₆ alkyl- such as C₁₋₆ alkyl(O)₂SC₁₋₆ alkyl-), sulfonamidoalkyl (e.g., ₂HRN(O)SC₁₋₆ alkyl, H(C₁₋₆ alkyl)N(O)SC₁₋₆ alkyl-).

As used herein, term “alkenyl” denotes groups formed from straight chain, branched or cyclic hydrocarbon residues containing at least one carbon to carbon double bond including ethylenically mono-, di- or polyunsaturated alkyl or cycloalkyl groups as previously defined, for example C₂₋₄ alkenyl, or C₂₋₂₀ or C₂₋₁₀. Thus, alkenyl is intended to include propenyl, butylenyl, pentenyl, hexaenyl, heptaenyl, octaenyl, nonaenyl, decenyl, undecenyl, dodecenyl, tridecenyl, tetradecenyl, pentadecenyl, hexadecenyl, heptadecenyl, octadecenyl, nondecenyl, eicosenyl hydrocarbon groups with one or more carbon to carbon double bonds. Examples of alkenyl include vinyl, allyl, 1-methylvinyl, butenyl, iso-butenyl, 3-methyl-2-butenyl, 1-pentenyl, cyclopentenyl, 1-methyl-cyclopentenyl, 1-hexenyl, 3-hexenyl, cyclohexenyl, 1-heptenyl, 3-heptenyl, bicycloheptenyl, 1-octenyl, cyclooctenyl, 1-nonenyl, 2-nonenyl, 3-nonenyl, 1-decenyl, 3-decenyl, 1,3-butadienyl, 1,4-pentadienyl, 1,3-cyclopentadienyl, 1,3-hexadienyl, 1,4-hexadienyl, 1,3-cyclohexadienyl, 1,4-cyclohexadienyl, 1,3-cycloheptadienyl, 1,3,5-cycloheptatrienyl and 1,3,5,7-cyclooctatetraenyl. An alkenyl group may be optionally substituted by one or more optional substituents as herein defined.

As used herein the term “alkynyl” denotes groups formed from straight chain, branched or cyclic hydrocarbon residues containing at least one carbon-carbon triple bond including ethylenically mono-, di- or polyunsaturated alkyl or cycloalkyl groups as previously defined, for example, C₂₋₄₀ alkenyl, or C₂₋₂₀ or C₂₋₁₀. Thus, alkynyl is intended to include propynyl, butylynyl, pentynyl, hexaynyl, heptaynyl, octaynyl, nonaynyl, decynyl, undecynyl, dodecynyl, tridecynyl, tetradecynyl, pentadecynyl, hexadecynyl, heptadecynyl, octadecynyl, nondecynyl, eicosynyl hydrocarbon groups with one or more carbon to carbon triple bonds. Examples of alkynyl include ethynyl, 1-propynyl, 2-propynyl, and butynyl isomers, and pentynyl isomers. An alkynyl group may be optionally substituted by one or more optional substituents as herein defined.

An alkenyl group may comprise a carbon to carbon triple bond and an alkynyl group may comprise a carbon to carbon double bond (i.e. so called ene-yne or yne-ene groups).

As used herein, the term “aryl” (or “carboaryl)” denotes any of single, polynuclear, conjugated and fused residues of aromatic hydrocarbon ring systems. Examples of aryl include phenyl, biphenyl, terphenyl, quaterphenyl, naphthyl, tetrahydronaphthyl, anthracenyl, dihydroanthracenyl, benzanthracenyl, dibenzanthracenyl, phenanthrenyl, fluorenyl, pyrenyl, idenyl, azulenyl, chrysenyl. Preferred aryl include phenyl and naphthyl. An aryl group may be optionally substituted by one or more optional substituents as herein defined.

As used herein, the terms “alkylene”, “alkenylene”, and “arylene” are intended to denote the divalent forms of “alkyl”, “alkenyl”, and “aryl”, respectively, as herein defined.

The term “halogen” (“halo”) denotes fluorine, chlorine, bromine or iodine (fluoro, chloro, bromo or iodo). Preferred halogens are chlorine, bromine or iodine.

The term “carbocyclyl” includes any of non-aromatic monocyclic, polycyclic, fused or conjugated hydrocarbon residues, preferably C₃₋₂₀ (e.g. C₃₋₁₀ or C₃₋₈). The rings may be saturated, e.g. cycloalkyl, or may possess one or more double bonds (cycloalkenyl) and/or one or more triple bonds (cycloalkynyl). Particularly preferred carbocyclyl moieties are 5-6-membered or 9-10 membered ring systems. Suitable examples include cyclopropyl, cyclobutyl, cyclopentyl, cyclohexyl, cycloheptyl, cyclooctyl, cyclononyl, cyclodecyl, cyclopentenyl, cyclohexenyl, cyclooctenyl, cyclopentadienyl, cyclohexadienyl, cyclooctatetraenyl, indanyl, decalinyl and indenyl.

The term “heterocyclyl” when used alone or in compound words includes any of monocyclic, polycyclic, fused or conjugated hydrocarbon residues, preferably C₃₋₂₀ (e.g. C₃₋₁₀ or C₃₋₈) wherein one or more carbon atoms are replaced by a heteroatom so as to provide a non-aromatic residue. Suitable heteroatoms include O, N, S, P and Se, particularly O, N and S. Where two or more carbon atoms are replaced, this may be by two or more of the same heteroatom or by different heteroatoms. The heterocyclyl group may be saturated or partially unsaturated, i.e. possess one or more double bonds. Particularly preferred heterocyclyl are 5-6 and 9-10 membered heterocyclyl. Suitable examples of heterocyclyl groups may include azridinyl, oxiranyl, thiiranyl, azetidinyl, oxetanyl, thietanyl, 2H-pyrrolyl, pyrrolidinyl, pyrrolinyl, piperidyl, piperazinyl, morpholinyl, indolinyl, imidazolidinyl, imidazolinyl, pyrazolidinyl, thiomorpholinyl, dioxanyl, tetrahydrofuranyl, tetrahydropyranyl, tetrahydropyrrolyl, tetrahydrothiophenyl, pyrazolinyl, dioxalanyl, thiazolidinyl, isoxazolidinyl, dihydropyranyl, oxazinyl, thiazinyl, thiomorpholinyl, oxathianyl, dithianyl, trioxanyl, thiadiazinyl, dithiazinyl, trithianyl, azepinyl, oxepinyl, thiepinyl, indenyl, indanyl, 3H-indolyl, isoindolinyl, 4H-quinolazinyl, chromenyl, chromanyl, isochromanyl, pyranyl and dihydropyranyl.

The term “heteroaryl” includes any of monocyclic, polycyclic, fused or conjugated hydrocarbon residues, wherein one or more carbon atoms are replaced by a heteroatom so as to provide an aromatic residue. Preferred heteroaryl have 3-20 ring atoms, e.g. 3-10. Particularly preferred heteroaryl are 5-6 and 9-10 membered bicyclic ring systems. Suitable heteroatoms include, O, N, S, P and Se, particularly O, N and S. Where two or more carbon atoms are replaced, this may be by two or more of the same heteroatom or by different heteroatoms. Suitable examples of heteroaryl groups may include pyridyl, pyrrolyl, thienyl, imidazolyl, furanyl, benzothienyl, isobenzothienyl, benzofuranyl, isobenzofuranyl, indolyl, isoindolyl, pyrazolyl, pyrazinyl, pyrimidinyl, pyridazinyl, indolizinyl, quinolyl, isoquinolyl, phthalazinyl, 1,5-naphthyridinyl, quinozalinyl, quinazolinyl, quinolinyl, oxazolyl, thiazolyl, isothiazolyl, isoxazolyl, triazolyl, oxadialzolyl, oxatriazolyl, triazinyl, and furazanyl.

The term “acyl” either alone or in compound words denotes a group containing the agent C═O (and not being a carboxylic acid, ester or amide) Preferred acyl includes C(O)—R^{x}, wherein R^{x} is hydrogen or an alkyl, alkenyl, alkynyl, aryl, heteroaryl, carbocyclyl, or heterocyclyl residue. Examples of acyl include formyl, straight chain or branched alkanoyl (e.g. C₁₋₂₀) such as, acetyl, propanoyl, butanoyl, 2-methylpropanoyl, pentanoyl, 2,2-dimethylpropanoyl, hexanoyl, heptanoyl, octanoyl, nonanoyl, decanoyl, undecanoyl, dodecanoyl, tridecanoyl, tetradecanoyl, pentadecanoyl, hexadecanoyl, heptadecanoyl, octadecanoyl, nonadecanoyl and icosanoyl; cycloalkylcarbonyl such as cyclopropylcarbonyl cyclobutylcarbonyl, cyclopentylcarbonyl and cyclohexylcarbonyl; aroyl such as benzoyl, toluoyl and naphthoyl; aralkanoyl such as phenylalkanoyl (e.g. phenylacetyl, phenylpropanoyl, phenylbutanoyl, phenylisobutylyl, phenylpentanoyl and phenylhexanoyl) and naphthylalkanoyl (e.g. naphthylacetyl, naphthylpropanoyl and naphthylbutanoyl]; aralkenoyl such as phenylalkenoyl (e.g. phenylpropenoyl, phenylbutenoyl, phenylmethacryloyl, phenylpentenoyl and phenylhexenoyl and naphthylalkenoyl (e.g. naphthylpropenoyl, naphthylbutenoyl and naphthylpentenoyl); aryloxyalkanoyl such as phenoxyacetyl and phenoxypropionyl; arylthiocarbamoyl such as phenylthiocarbamoyl; arylglyoxyloyl such as phenylglyoxyloyl and naphthylglyoxyloyl; arylsulfonyl such as phenylsulfonyl and napthylsulfonyl; heterocycliccarbonyl; heterocyclicalkanoyl such as thienylacetyl, thienylpropanoyl, thienylbutanoyl, thienylpentanoyl, thienylhexanoyl, thiazolylacetyl, thiadiazolylacetyl and tetrazolylacetyl; heterocyclicalkenoyl such as heterocyclicpropenoyl, heterocyclicbutenoyl, heterocyclicpentenoyl and heterocyclichexenoyl; and heterocyclicglyoxyloyl such as thiazolyglyoxyloyl and thienylglyoxyloyl. The R^{x} residue may be optionally substituted as described herein.

The term “sulfoxide”, either alone or in a compound word, refers to a group —S(O)R^{Y} wherein R^{y} is selected from hydrogen, alkyl, alkenyl, alkynyl, aryl, heteroaryl, heterocyclyl, carbocyclyl, and aralkyl. Examples of preferred R^{y} include C₁₋₂₀alkyl, phenyl and benzyl.

The term “sulfonyl”, either alone or in a compound word, refers to a group S(O)₂—R^{y}, wherein R^{y} is selected from hydrogen, alkyl, alkenyl, alkynyl, aryl, heteroaryl, heterocyclyl, carbocyclyl and aralkyl. Examples of preferred R^{y} include C₁₋₂₀alkyl, phenyl and benzyl.

The term “sulfonamide”, either alone or in a compound word, refers to a group S(O)NR^{y}R^{y} wherein each R^{y} is independently selected from hydrogen, alkyl, alkenyl, alkynyl, aryl, heteroaryl, heterocyclyl, carbocyclyl, and aralkyl. Examples of preferred R^{y} include C₁₋₂₀alkyl, phenyl and benzyl. In a preferred embodiment at least one R^{y} is hydrogen. In another form, both R^{y} are hydrogen.

The term, “amino” is used here in its broadest sense as understood in the art and includes groups of the formula NR^{A}R^{B} wherein R^{A} and R^{B} may be any independently selected from hydrogen, alkyl, alkenyl, alkynyl, aryl, carbocyclyl, heteroaryl, heterocyclyl, aralkyl, and acyl. R^{A} and R^{H}, together with the nitrogen to which they are attached, may also form a monocyclic, or polycyclic ring system e.g. a 3-10 membered ring, particularly, 5-6 and 9-10 membered systems. Examples of “amino” include NH₂, NHalkyl (e.g. C₁₋₂₀alkyl), NHaryl (e.g. NHphenyl), NHaralkyl (e.g. NHbenzyl), NHacyl (e.g. NHC(O)C₁₋₂₀alkyl, NHC(O)phenyl), Nalkylalkyl (wherein each alkyl, for example C₁₋₂₀, may be the same or different) and 5 or 6 membered rings, optionally containing one or more same or different heteroatoms (e.g. O, N and S).

The term “amido” is used here in its broadest sense as understood in the art and includes groups having the formula C(O)NR^{A}R^{B}, wherein R^{A} and R^{H} are as defined as above. Examples of amido include C(O)NH₂, C(O)NHalkyl (e.g. C₁₋₂₀alkyl), C(O)NHaryl (e.g. C(O)NHphenyl), C(O)NHaralkyl (e.g. C(O)NHbenzyl), C(O)NHacyl (e.g. C(O)NHC(O)C₁₋₂₀alkyl, C(O)NHC(O)phenyl), C(O)Nalkylalkyl (wherein each alkyl, for example C₁₋₂₀, may be the same or different) and 5 or 6 membered rings, optionally containing one or more same or different heteroatoms (e.g. O, N and S).

The term “carboxy ester” is used here in its broadest sense as understood in the art and includes groups having the formula CO₂R^{z}, wherein R^{z} may be selected from groups including alkyl, alkenyl, alkynyl, aryl, carbocyclyl, heteroaryl, heterocyclyl, aralkyl, and acyl. Examples of carboxy ester include CO₂C₁₋₂₀alkyl, CO₂aryl (e.g., CO₂phenyl), CO₂aralkyl (e.g. CO₂ benzyl).

The term “heteroatom” or “hetero” as used herein in its broadest sense refers to any atom other than a carbon atom which may be a member of a cyclic organic group. Particular examples of heteroatoms include nitrogen, oxygen, sulfur, phosphorous, boron, silicon, selenium and tellurium, more particularly nitrogen, oxygen and sulfur.

The invention will now be described with reference to the following examples. However, it is to be understood that the examples are provided by way of illustration of the invention and that they are in no way limiting to the scope of the invention.

### EXAMPLES

Chemicals and Materials:

Chemicals were used as received without further purification if not stated otherwise: 2,5-Dimethylphenol (≥99%, Sigma-Aldrich), 3,5-Dimethylphenol (≥99%, Sigma-Aldrich), 2,5-Dimethylresorcinol (95%, Sigma-Aldrich), Trifluoroacetic acid (99.9% ABCR), Hexamethylene tetramine (99% ABCR), Methyl iodide (99%, Merck), α,α-Dibromo-p-xylene (97%, Sigma-Aldrich), N,N′-4,4′-diphenylmethane-bis-maleimide (99% Sigma-Aldrich), N,N′-(1,3-Phenylene)dimaleimide (98%, Sigma-Alrdrich), N,N′-(1,2-Phenylene)dimaleimide (98%, Sigma-Aldrich), toluene 1,3-bismaleimide (98%, Evonik), 1,4-dimethylhydroquinone (obtained via reduction of 1,4-dimethylbenzoquinone 98%, Sigma-Aldrich), Potassium Carbonate (99.9%, Merck), N,N-Dimethylformamide (DMF, anhydrous 99.8%, Sigma-Aldrich), acetonitrile (ACN, HPLC-grade, Fisher), dimethyl sulfoxide (DMSO, anhydrous 99.9%, Sigma-Aldrich), methanol (MeOH, analytical reagent, Ajax Finechem), tetrahydrofuran (THF, analytical reagent, Fisher), chloroform (analytical reagent, Fisher), cyclohexane (CH, analytical reagent, Ajax Finechem), ethyl acetate (EA, analytical reagent, Fisher), dichloromethane (DCM, analytical reagent, Fisher), acetonitrile-d₃ (99.8% D, Cambridge Isotope Laboratories), chloroform-d (99.8% D, Cambridge Isotope Laboratories), dimethylsulfoxide-d₆ (99.9% D, Cambridge Isotope Laboratories).

Instruments

Bruker 600 MHz NMR

¹H, ¹³C-NMR as well as DEPT 135, COSY, HSQC and HMBC-spectra were recorded on a Bruker System 600 Ascend LH, equipped with an BBO-Probe (5 mm) with z-gradient (¹H: 600.13 MHz, ¹³C 150.90 MHz). The δ-scale was normalized relative to the solvent signal of CHCl₃, DMSO or ACN for ¹H spectra and for ¹³C spectra on the middle signal of CHCl₃ triplet, the DMSO quintet or ACN septet. The annotation of the signals is based on HSQC-, HMBC- COSY- and DEPT-experiments.

Shimadzu UV-VIS

UV-Vis spectra were recorded on a Shimadzu UV-2700 spectrophotometer equipped with a CPS-100 electronic temperature control cell positioner. Samples were prepared in solvent stated in the spectra and measured in Hellma Analytics quartz high precision cuvettes at 20° C.

Interchim XS420

Flash chromatography was performed on a Interchim XS420+ flash chromatography system consisting of a SP-in-line filter 20-μm, an UV-VIS detector (200-800 nm) The separations were performed using an Interchim dry load column and a Interchim Puriflash Silica HP 30 μm column after deposition on Celite® 565 (Sigma-Aldrich).

SEM

Scanning Electron Microscopy: SEM images were captured using a Tescan MIRA3 SEM at 5 kV using an SE detector. Samples were prepared by dispersing the particles and drop casting onto an SEM stub. Samples were coated with a 3-10 nm layer of gold or Pt. Analysis was done in ImageJ using the following equations:

$${D}_{n} = \frac{\sum {N}_{i} {D}_{i}}{\sum {N}_{i}} {D}_{w} = \frac{\sum {N}_{i} {D}_{i}^{4}}{\sum {N}_{i} {D}_{i}^{3}}$$

Where Dₙ is the number-average diameter, D_{w} is the weight-average diameter, Nᵢ is the number of particles measured, and Dᵢ is the diameter of the measured particle. The dispersity D can then be calculated as

$$Ð = \frac{{D}_{w}}{{D}_{n}}$$

Bottle Roller

Reactions performed on a bottle roller employed a ThermoFisher Scientific Bottle/Tube Roller at 2-10 rpm for a 2-20 mL reaction vial.

### Monomer Synthesis

### Example 1: Synthesis of Monomer 1 (4-Methoxy-2,5-dimethylisophthalaldehyde)

### A 1) Synthesis of 4-hydroxy-2,5-dimethylisophthalaldehyde

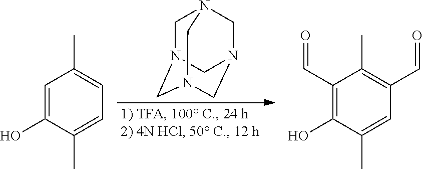

In a 250 mL round bottom flask, a solution of 2,5-dimethylphenol (5.00 g, 40.93 mmol, 1.00 eq) in 32.7 mL TFA was prepared and hexamethylenetetramine (20.80 g, 163.71 mmol, 4.00 eq) was added. The resulting viscous solution was stirred under inert atmosphere at 100° C. in an oil bath for 24 h. Afterwards, the reaction mixture was cooled to ambient temperature and 72 mL 4 N HCl were added. The mixture was heated to 50° C. whilst passing through nitrogen for 12 h. Finally, the resulting solution was cooled at ambient temperature, diluted with 50 mL water and cooled in a refrigerator at 7° C. overnight. The resulting precipitate is filtered off, washed with 10 mL cold water and dried in vacuum. The resulting crude product was either purified via flash chromatography (EA:CH 10:90-20:80 v/v) or sublimated under reduced pressure at 60° C. The product is obtained as a slightly yellow crystals (4.30 g, 59% yield).

The NMR spectra are consistent with earlier reported results (Tetrahedron Lett. 51, 2335-2338, 2010).

¹H NMR (600 MHz, Chloroform-d) δ: 12.98 (s, 1H), 10.48 (s, 1H), 10.24 (s, 1H), 7.86 (s, 1H), 2.93 (s, 3H), 2.27 (s, 3H).

¹³C NMR (151 MHz, Chloroform-d) 8: 195.58, 190.06, 166.38, 144.16, 140.00, 126.25, 126.12, 117.81, 15.05, 12.14.

### A 2) Synthesis of 4-methoxy-2,5-dimethylisophthalaldehyde

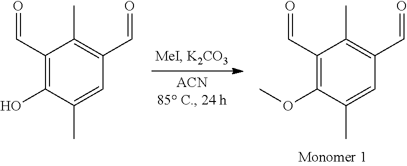

4-Hydroxy-2,5-dimethylisophthalaldehyde (3.00 g, 16.84 mmol, 1.00 eq) was dissolved in 100 mL dry acetonitrile under inert atmosphere. Methyl iodide (1.57 mL, 3.58 g, 1.50 eq) was added via syringe. Anhydrous K₂CO₃ (2.70 g, 21.05 mmol, 1.25 eq) was then added and the suspension stirred at 85° C. for 24 h until complete consumption of the starting material. Afterwards the reaction mixture is cooled to ambient temperature, 150 mL 0.1 N HCl and 250 mL ethyl acetate were added, the organic phase separated, the aqueous phase washed twice with 50 mL ethyl acetate and the combined organic phases washed with brine, dried over MgSO₄, the volatiles removed under reduced pressure and the residual crude product was purified via flash chromatography (isocratic cyclohexane:ethyl acetate 85:15 v/v). The product was obtained as colorless crystals (3.04 g, 94% yield).

¹H NMR (600 MHz, Chloroform-d) δ: 10.54 (s, 1H), 10.37 (s, 1H), 7.90 (s, 1H), 3.88 (s, 3H), 2.83 (s, 3H), 2.35 (s, 3H).

¹³C NMR (151 MHz, Chloroform-d) δ: 192.90, 190.86, 166.80, 142.19, 138.03, 131.25, 130.19, 129.36, 62.99, 15.58, 14.25.

### Example 2: Synthesis of Monomer 2 (4,6-Dimethoxy-2,5-dimethylisophthalaldehyde)

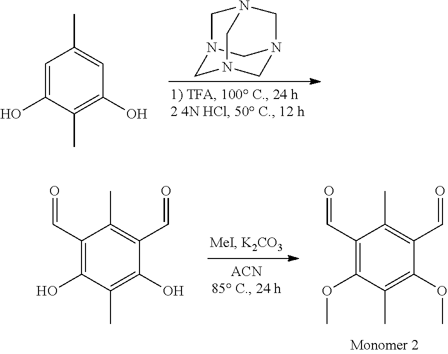

In a 25 mL round bottom flask, a solution of 2,5-dimethylresorcinol (500 mg, 3.62 mmol, 1.00 eq) in 2.9 mL TFA was prepared and hexamethylenetetramine (1.84 g, 14.58 mmol, 4.00 eq) was added. The resulting viscous solution was stirred under inert atmosphere and at to 100° C. in an oil bath for 24 h. Afterwards, the reaction mixture was cooled at ambient temperature and 6.5 mL 4 N HCl were added. The mixture was heated to 50° C. whilst passing through nitrogen for 12 h. Finally, the resulting solution was cooled at ambient temperature, diluted with 50 mL water and cooled in a refrigerator at 7° C. overnight. The resulting precipitate was filtered of, washed with 10 mL cold water and dried in vacuum. The resulting crude product was dissolved in 15 mL dry acetonitrile under inert atmosphere. Methyl iodide (675 μL, 1.54 g, 3.00 eq) was added via syringe. Subsequently, anhydrous K₂CO₃ (974 mg, 7.60 mmol, 2.1 eq) was added and the suspension stirred at 85° C. for 24 h until complete consumption of the starting material. Afterwards, the reaction mixture was cooled to ambient temperature, 30 mL 0.1 N HCl and 50 mL ethyl acetate were added, the organic phase separated, the aqueous phase washed twice with 50 mL ethyl acetate and the combined organic phases washed with brine, dried over MgSO₄, the volatiles removed under reduced pressure and the residual crude product was purified via flash chromatography (isocratic cyclohexane:ethyl acetate 80:20 v/v). The product was obtained as beige solid (257 mg, 32% yield).

¹H NMR (600 MHz, ACN-d₃) δ: 10.42 (s, 2H), 3.85 (s, 6H), 2.64 (d, J=0.7 Hz, 3H), 2.23 (d, J=0.7 Hz, 3H).

¹³C NMR (151 MHz, ACN-d₃) 8:193.34, 167.94, 142.60, 127.04, 124.89, 63.57, 16.17, 9.14.

### B 2) Synthesis of 4,6-dimethoxy-2,5-dimethylisophthalaldehyde

(2000 mg, 10.30 mmol, 1.00 eq) was dissolved in 92 mL dry DMF under inert atmosphere. Mel (1.92 mL, 4.38 g, 30.90 mmol, 3.00 eq) was added via syringe. Anhydrous K₂CO₃ (3.30 g, 25.75 mmol, 2.50 eq) was then added, the resulting mixture degassed by passing through nitrogen for 20 min and the suspension stirred at 70° C. for 20 h until complete consumption of the starting material. Afterwards the reaction mixture is cooled to room temperature, 150 mL H₂O and 200 mL ethyl acetate are added, the organic phase separated, the aqueous phase washed twice with 50 mL ethyl acetate and the combined organic phases washed with brine, dried over MgSO₄, the volatiles removed under reduced pressure and the residual crude product was purified via flash chromatography (isocratic EE:CH 10:90 v/v).

¹H NMR (600 MHz, ACN-d₃) δ: 10.42 (s, 2H), 3.85 (s, 6H), 2.64 (d, J=0.7 Hz, 3H), 2.23 (d, J=0.7 Hz, 3H).

¹³C NMR (151 MHz, ACN-d₃) 8:193.34, 167.94, 142.60, 127.04, 124.89, 63.57, 16.17, 9.14.

### Example 3: Synthesis of Monomer 3 (2-methoxy-4,6-dimethylisophthalaldehyde)

### C 1) Synthesis of 2-hydroxy-4,6-dimethylisophthalaldehyde

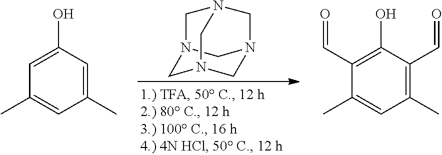

In a 250 mL round bottom flask, a solution of 3,5-dimethylphenol (3.00 g, 24.56 mmol, 1.00 eq) in 19.6 mL TFA was prepared and hexamethylenetetramine (12.46 g, 98.22 mmol, 4.00 eq) was added. The resulting viscous solution was stirred under inert atmosphere at 50° C. in an oil bath for 12 h, at 80° C. for 12 h and finally at 100° C. for 16 h. Afterwards, the reaction mixture was cooled to ambient temperature and 44 mL 4 N HCl were added. The mixture was heated to 50° C. whilst passing through nitrogen for 12 h. Finally, the resulting solution was cooled at ambient temperature, diluted with 50 mL water and extracted 5 times with 50 mL DCM each. The combined organic phases were dried over MgSO₄, filtered and the volatiles removed under reduced pressure. The resulting crude product was either purified via flash chromatography (EE:CH 10:90-20:80 v/v) or sublimated under reduced pressure at 60° C. The product is obtained as a slightly yellow crystals (1.37 g, 29% yield).

¹H NMR (600 MHz, Acetonitrile-d3) δ 12.87 (s, 1H), 10.39 (s, 2H), 6.69 (s, 1H), 2.56 (d, J=0.8 Hz, 6H).

¹³C NMR (151 MHz, Acetonitrile-d3) δ 194.06, 167.69, 150.80, 126.51, 119.91, 20.37.

### C 2) Synthesis of 4-methoxy-2,5-dimethylisophthalaldehyde

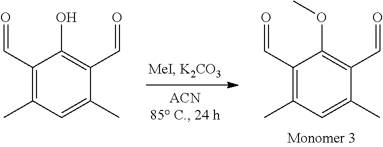

2-hydroxy-4,6-dimethylisophthalaldehyde (1.25 g, 7.02 mmol, 1.00 eq) was dissolved in 45 mL dry acetonitrile under inert atmosphere. Methyl iodide (0.66 mL, 1.49 g, 10.52 mmol, 1.50 eq) was added via syringe. Anhydrous K₂CO₃ (1.12 g, 8.77 mmol, 1.25 eq) was then added and the suspension stirred at 85° C. for 24 h until complete consumption of the starting material. Afterwards the reaction mixture is cooled to ambient temperature, 50 mL 0.1 N HCl and 100 mL ethyl acetate were added, the organic phase separated, the aqueous phase washed twice with 50 mL ethyl acetate and the combined organic phases washed with brine, dried over MgSO₄, the volatiles removed under reduced pressure and the residual crude product was purified via flash chromatography (isocratic cyclohexane:ethyl acetate 90:10 v/v). The product was obtained as colorless crystals (1.23 g, 91% yield).

¹H NMR (600 MHz, Chloroform-d) δ 10.49 (s, 2H), 6.90 (s, 1H), 3.97 (s, 3H), 2.59 (s, 6H).

¹³C NMR (151 MHz, Chloroform-d) δ 190.86, 169.27, 147.85, 131.63, 126.00, 66.91, 21.75.

### Example 4: Synthesis of Monomer 4 (4,4′-((1,4-phenylenebis(methylene))bis(oxy))bis(2,5-dimethylisophthalaldehyde))

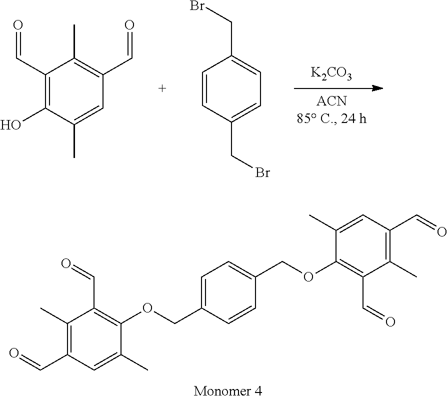

4-Hydroxy-2,5-dimethylisophthalaldehyde (200 mg, 1.12 mmol, 2.25 eq) was dissolved in 20 mL dry acetonitrile under inert atmosphere. α,α-Dibromo-p-xylene (131 mg, 0.50 mmol, 1.00 eq) was added. Anhydrous K₂CO₃ (2.70 g, 21.05 mmol, 1.25 eq) was then added and the suspension stirred at 85° C. for 24 h until complete consumption of the starting material. Afterwards the reaction mixture is cooled to ambient temperature, 15 mL 0.1 N HCl and 250 mL DCM were added, the organic phase separated, the aqueous phase washed three times with 25 mL DCM and the combined organic phases washed with brine, dried over MgSO₄, the volatiles removed under reduced pressure and the residual crude product was purified via flash chromatography (gradient DCM:MeOH 99:1-95:5 v/v). The product was obtained as colorless solid (177.2 mg, 81% yield).

¹H NMR (600 MHz, Chloroform-d) δ 10.50 (s, 2H), 10.40 (s, 2H), 7.94 (s, 2H), 7.45 (s, 4H), 5.00 (s, 4H), 2.84 (s, 6H), 2.37 (t, J=0.7 Hz, 6H).

¹³C NMR (151 MHz, Chloroform-d) δ 192.79, 190.86, 165.12, 142.17, 138.03, 136.33, 131.48, 130.43, 129.74, 128.66, 77.31, 16.05, 14.30.

### Example 5: Synthesis of Monomer 5 (4,6-Dimethoxy-2,5-dimethylisophthalaldehyde)

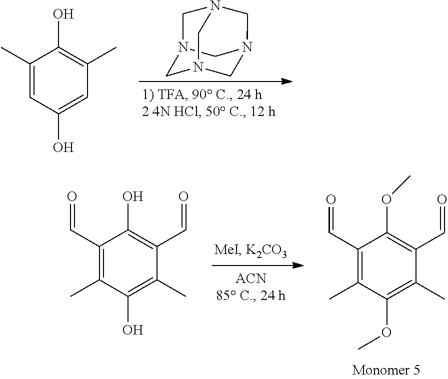

In a 50 mL round bottom flask, a solution of 2,6-dimethylhydroquinone (1.00 g, 7.24 mmol, 1.00 eq) in 5.8 mL TFA was prepared and hexamethylenetetramine (3.67 g, 28.95 mmol, 4.00 eq) was added. The resulting viscous solution was stirred under inert atmosphere and at to 90° C. in an oil bath for 24 h. Afterwards, the reaction mixture was cooled at ambient temperature and 13 mL 4 N HCl were added. The mixture was heated to 50° C. whilst passing through nitrogen for 12 h. Finally, the resulting solution was cooled at ambient temperature, diluted with 50 mL water and cooled in a refrigerator at 7° C. overnight. The resulting precipitate was filtered off washed with 10 mL cold water and dried in vacuum. The resulting crude product was dissolved in 60 mL dry acetonitrile under inert atmosphere. Methyl iodide (1350 μL, 3.18 g, 3.00 eq) was added via syringe. Subsequently, anhydrous K₂CO₃ (1940 mg, 15.30 mmol, 2.10 eq) was added and the suspension stirred at 85° C. for 24 h until complete consumption of the starting material. Afterwards, the reaction mixture was cooled to ambient temperature, 60 mL 0.1 N HCl and 150 mL ethyl acetate were added, the organic phase separated, the aqueous phase washed twice with 50 mL ethyl acetate and the combined organic phases washed with brine, dried over MgSO₄, the volatiles removed under reduced pressure and the residual crude product was purified via flash chromatography (isocratic cyclohexane:ethyl acetate 65:35 v/v). The product was obtained as colorless solid (521 mg, 29% yield).

¹H NMR (600 MHz, Chloroform-d) δ 10.43 (s, 2H), 3.91 (s, 3H), 3.62 (s, 3H), 2.51 (s, 6H).

¹³C NMR (151 MHz, Chloroform-d) δ 190.95, 164.73, 154.30, 140.69, 126.71, 66.73, 60.34, 13.67.

### Example 6: Synthesis of Monomer 6 (2,5-dimethoxy-3,6-dimethylterephthalaldehyde)

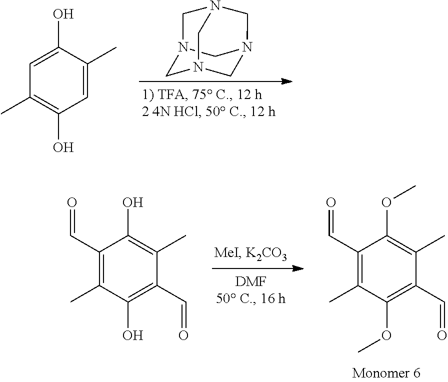

In a 50 mL round bottom flask, a solution of 2,5-dimethylhydroquinone (1.00 g, 7.24 mmol, 1.00 eq) in 5.8 mL TFA was prepared and hexamethylenetetramine (3.67 g, 28.95 mmol, 4.00 eq) was added. The resulting viscous solution was stirred under inert atmosphere and at to 90° C. in an oil bath for 24 h. Afterwards, the reaction mixture was cooled at ambient temperature and 13 mL 4 N HCl were added. The mixture was heated to 50° C. whilst passing through nitrogen for 12 h. Finally, the resulting solution was cooled at ambient temperature, extracted 3 times with DCM, the combined organic phases washed with water and brine, dried over MgSO₄, filtered and the volatiles evaporated under reduced pressure. The resulting crude product was dissolved in 20 mL dry DMF under inert atmosphere. Methyl iodide (1350 μL, 3.18 g, 3.00 eq) was added via syringe. Subsequently, anhydrous K₂CO₃ (1940 mg, 15.30 mmol, 2.10 eq) was added and the suspension stirred at 50° C. for 16 h until complete consumption of the starting material. Afterwards, the reaction mixture was cooled to ambient temperature, 60 mL 0.1 N HCl and 150 mL ethyl acetate were added, the organic phase separated, the aqueous phase washed twice with 50 mL ethyl acetate and the combined organic phases washed with brine, dried over MgSO₄, the volatiles removed under reduced pressure and the residual crude product was purified via flash chromatography (isocratic cyclohexane:ethyl acetate 90:10 v/v). The product was obtained as colorless solid (197 mg, 11% yield).

¹H NMR (600 MHz, Chloroform-d) δ 10.51 (s, 2H), 3.78 (s, 6H), 2.46 (s, 6H).

¹³C NMR (151 MHz, Chloroform-d) δ 192.97, 158.83, 132.68, 132.00, 63.39, 12.18.

General Procedure 1: Particle Synthesis in Batch

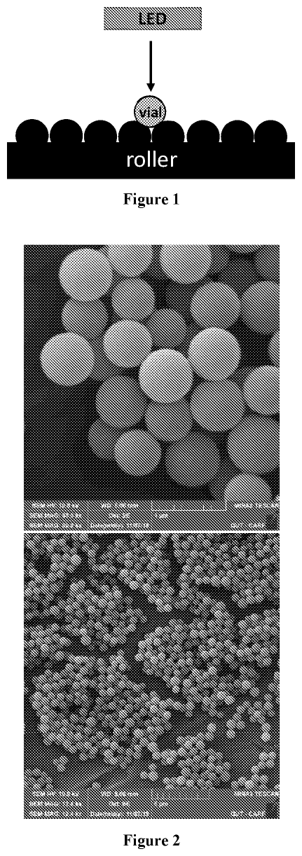

Narrow-disperse microspheres were successfully prepared by photo-induced step-growth Diels-Alder polymerisation. The method of preparing microspheres according to the present invention comprises preparing a homogeneous mixture comprising only the monomer(s) and solvent. Subsequently the solution is filtered, placed in crimp-cap vials, optionally degassed by passing through a stream of nitrogen and irradiated with a suitable light source under mild agitation. In a non-limiting setup, LEDs are used as light source and the agitation is provided by a bottle roller (refer to FIG. 1).

### Example 7: Synthesis of Polymer Spheres in Batch

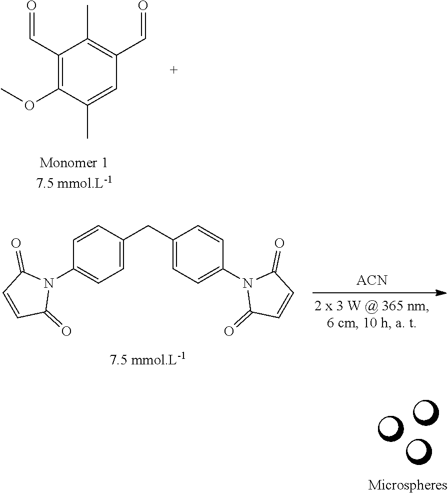

In one non-limiting example, monomer 1 and N,N′-4,4′-diphenylmethane-bis-maleimide were selected as monomers. The monomers were dissolved in acetonitrile (C_{monomer 1}=C_{bis-maleimide}=7.5 mmol L⁻¹; V=15 mL). The solution was passed through a 2.5 μM PTFE syringe filter and placed in a 20 mL crimp cap vial. Oxygen was removed by passing through a stream of nitrogen (N₂). Under irradiation with 2×3 W LED (λₘₐₓ=365 nm, 6 cm distance) on a bottle roller at 10 rpm, the clear solution gradually becomes heterogeneous upon irradiation. After 10 h, the turbid solution was centrifuged, the supernatant was removed and the solid pellet washed with DCM. The resulting particles were characterized via SEM (refer to FIG. 2, Dₙ 0.67 [μm]).

### Example 8: Synthesis of Polymer Spheres with Controlled Diameter in Batch

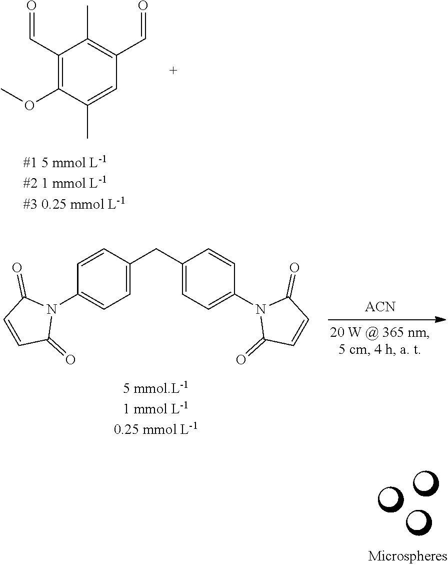

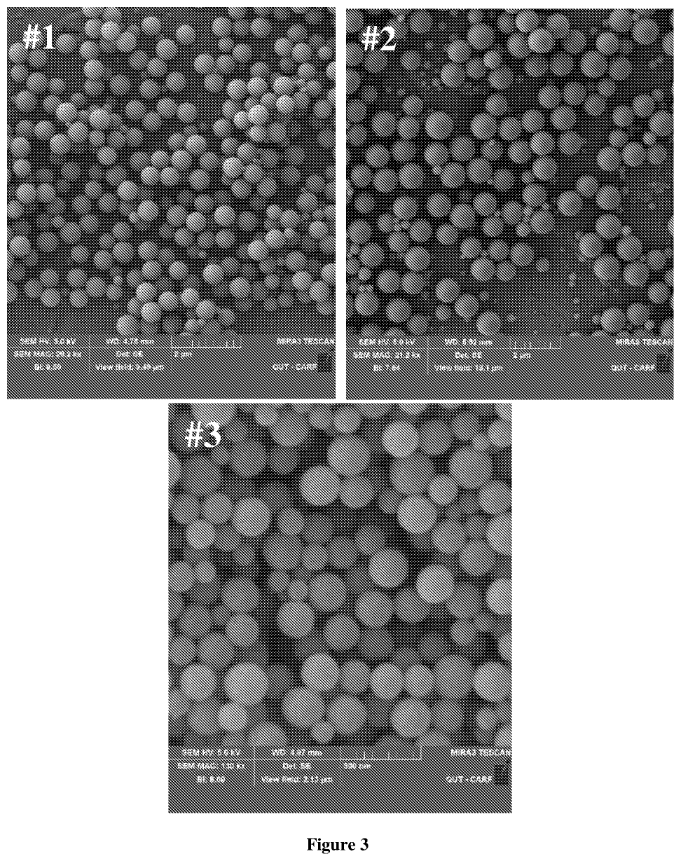

In one non-limiting example, monomer 1 and N,N′-4,4′-diphenylmethane-bis-maleimide were selected as monomers. The monomers were dissolved in acetonitrile (C_{monomer 1}=C_{bis-maleimide}=5 mmol L⁻¹ V=10 mL) and diluted 1/5 (C_{monomer 1}=C_{bis-maleimide}=0.25 mmol L⁻¹) and 1/20 v/v (C_{monomer 1}=C_{bis-maleimide}=0.25 mmol L⁻¹) with acetonitrile. The solutions were passed through a 2.5 μM PTFE syringe filter and placed in 5 mL individual crimp cap vials. Oxygen was removed by passing through a stream of nitrogen (N₂). Under irradiation with 20 W LED (λₘₐₓ=365 nm, 5 cm distance) on a bottle roller at 10 rpm, the clear solution gradually becomes heterogeneous upon irradiation. After 4 h, the turbid solution was centrifuged, the supernatant was removed and the solid pellet washed with DCM. The resulting particles were characterized via SEM (refer to FIG. 3 and Table 1).

TABLE 1
Microspheres from Example 8

| No | C [mmol L⁻¹] | Dₙ [μm] |
|---|---|---|
| #1 | 5 | 0.84 |
| #2 | 1 | 0.54 |
| #3 | 0.25 | 0.21 |

### Example 9: Synthesis of Polymer Spheres with Controlled Diameter in Batch, Variation of the bis-Maleimide

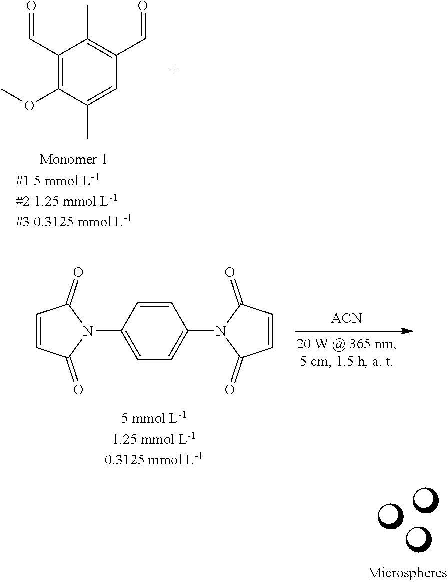

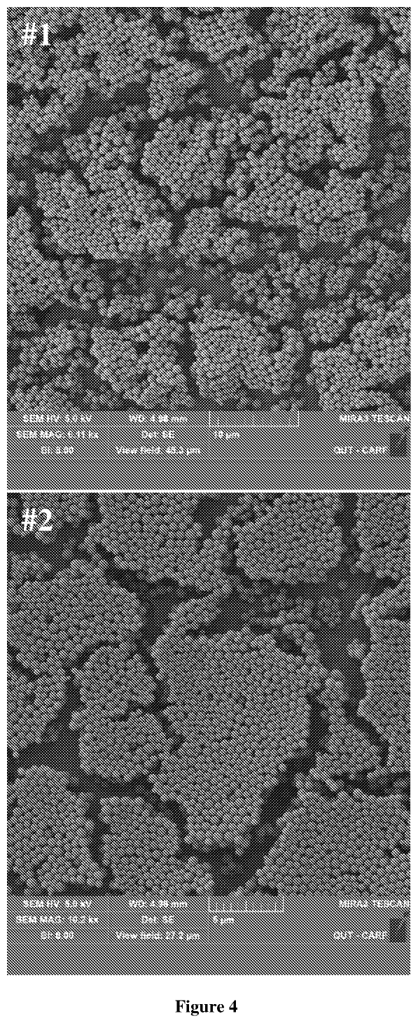

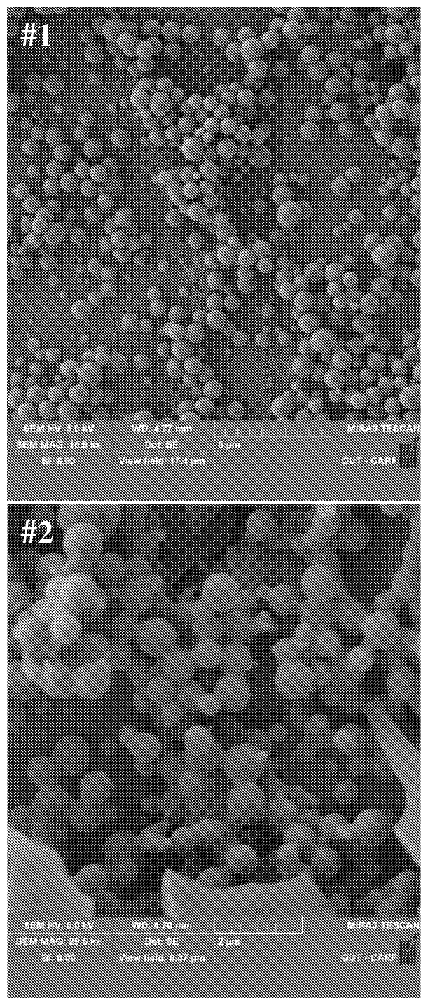

In one non-limiting example, monomer 1 and 1,4-phenylene-bis-maleimide were selected as monomers. The monomers were dissolved in acetonitrile (C_{monomer 1}=C_{bis-maleimide}=5 mmol L⁻¹ V=10 mL) and diluted 1/4 (C_{monomer 1}=C_{bis-maleimide}=1.25 mmol L⁻¹) and 1/16 v/v (C_{monomer 1}=C_{bis-maleimide}=0.3125 mmol L⁻¹) with acetonitrile. The solutions were passed through a 2.5 μM PTFE syringe filter and placed in 5 mL individual crimp cap vials. Oxygen was removed by passing through a stream of nitrogen (N₂). Under irradiation with 20 W LED (λₘₐₓ=365 nm, 5 cm distance) on a bottle roller at 10 rpm, the clear solution gradually becomes heterogeneous upon irradiation. After 1.5 h, the turbid solution was centrifuged, the supernatant was removed and the solid pellet washed with DCM. The resulting particles were characterized via SEM (refer to FIG. 4 and Table 2).

TABLE 2
Microspheres from Example 9

| No | C [mmol L⁻¹] | Dₙ [μm] |
|---|---|---|
| #1 | 5 | 0.8 |
| #2 | 1.25 | 0.5 |

### Example 10: Synthesis of Polymer Spheres with Controlled Diameter in Batch, Variation of the bis-Maleimide

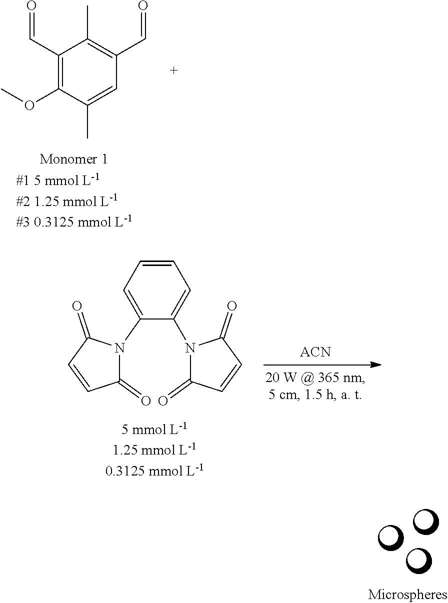

In one non-limiting example, monomer 1 and 1,2-phenylene-bis-maleimide were selected as monomers. The monomers were dissolved in acetonitrile (C_{monomer 1}=C_{bis-maleimide}=5 mmol L⁻¹ V=10 mL) and diluted 1/4 (C_{monomer 1}=C_{bis-maleimide}=1.25 mmol L⁻¹) and 1/16 v/v (C_{monomer 1}=C_{bis-maleimide}=0.3125 mmol L⁻¹) with acetonitrile. The solutions were passed through a 2.5 μM PTFE syringe filter and in 5 mL individual crimp cap vials. Oxygen was removed by passing through a stream of nitrogen (N₂). Under irradiation with 20 W LED (λₘₐₓ=365 nm, 5 cm distance) on a bottle roller at 10 rpm, the clear solution gradually becomes heterogeneous upon irradiation. After 1.5 h, the turbid solution was centrifuged, the supernatant was removed and the solid pellet washed with DCM. The resulting particles were characterized via SEM (refer to FIG. 5 and Table 3).

TABLE 3
Microspheres from Example 10

| No | C [mmol L⁻¹] | Dₙ [μm] |
|---|---|---|
| #1 | 5 | 0.75 |
| #2 | 1.25 | 0.65 |

### Example 11: Synthesis of Polymer Spheres with Controlled Diameter in Batch, Variation of the Dialdehyde

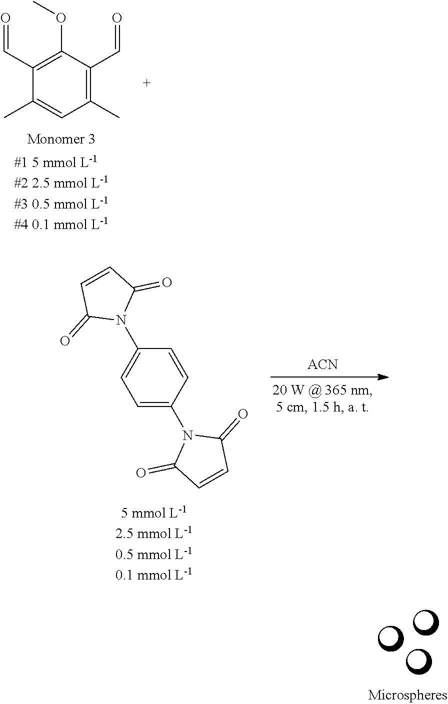

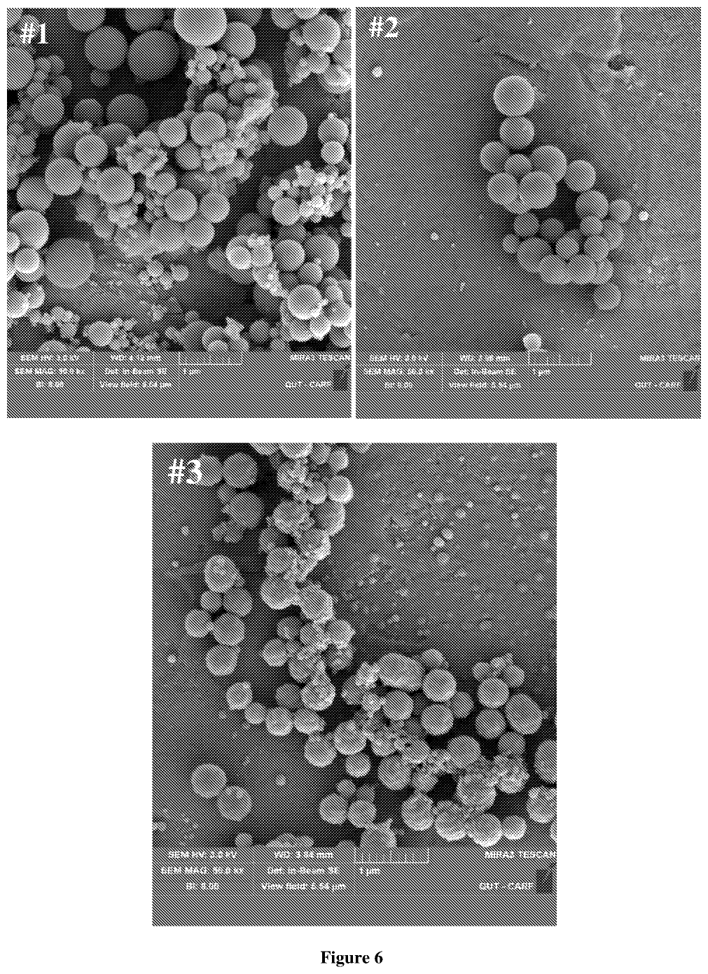

In one non-limiting example, monomer 3 and 1,4-phenylene-bis-maleimide were selected as monomers. The monomers were dissolved in acetonitrile (C_{monomer 3}=C_{bis-maleimide}=5 mmol L⁻¹ V=10 mL) and diluted 1/2 (C_{monomer 3}=C_{bis-maleimide}=2.5 mmol L⁻¹), 1/5 v/v (C_{monomer 3}=C_{bis-maleimide}=0.5 mmol L⁻¹) and 1/20 v/v (C_{monomer 3}=C_{bis-maleimide}=0.1 mmol L⁻¹) with acetonitrile. The solutions were passed through a 2.5 μM PTFE syringe filter and placed in 5 mL individual crimp cap vials. Oxygen was removed by passing through a stream of nitrogen (N₂). Under irradiation with 20 W LED (λₘₐₓ=365 nm, 5 cm distance) on a bottle roller at 10 rpm, the clear solution gradually becomes heterogeneous upon irradiation. After 1.5 h, the turbid solution was centrifuged, the supernatant was removed and the solid pellet washed with DCM. The resulting particles were characterized via SEM (refer to FIG. 6 and Table 4).

TABLE 4
Microspheres from Example 11

| No | C [mmol L⁻¹] | Dₙ [μm] |
|---|---|---|
| #1 | 5 | 0.7 |
| #2 | 2.5 | 0.5 |
| #3 | 0.5 | 0.4 |
| #4 | 0.1 | — |

### Example 12: Synthesis of Polymer Spheres with Controlled Diameter in Batch, Variation of the Dialdehyde

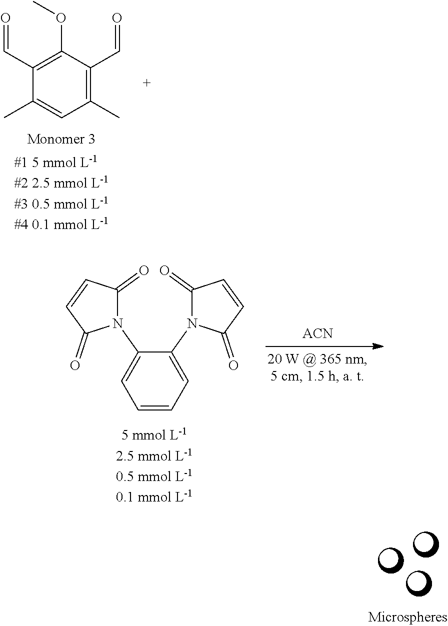

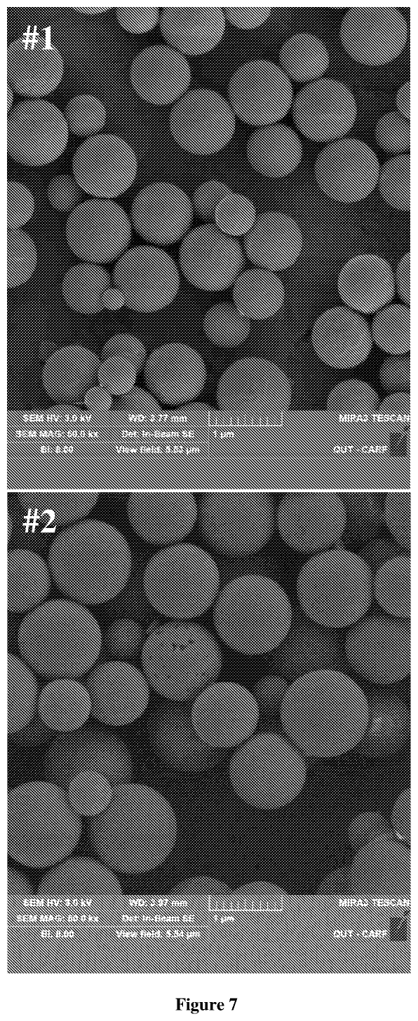

In one non-limiting example, monomer 3 and 1,2-phenylene-bis-maleimide were selected as monomers. The monomers were dissolved in acetonitrile (C_{monomer 3}=C_{bis-maleimide}=5 mmol L⁻¹ V=10 mL) and diluted 1/2 (C_{monomer 3}=C_{bis-maleimide}=2.5 mmol L⁻¹), 1/5 v/v (C_{monomer 3}=C_{bis-maleimide}=0.5 mmol L⁻¹) and 1/20 v/v (C_{monomer 3}=C_{bis-maleimide}=0.1 mmol L⁻¹) with acetonitrile. The solutions were passed through a 2.5 μM PTFE syringe filter and placed in 5 mL individual crimp cap vials. Oxygen was removed by passing through a stream of nitrogen (N₂). Under irradiation with 20 W LED (λₘₐₓ=365 nm, 5 cm distance) on a bottle roller at 10 rpm, the clear solution gradually becomes heterogeneous upon irradiation. After 1.5 h, the turbid solution was centrifuged, the supernatant was removed and the solid pellet washed with DCM. The resulting particles were characterized via SEM (refer to FIG. 7 and Table 5).

TABLE 5
Microspheres from Example 12

| No | C [mmol L⁻¹] | Dₙ [μm] |
|---|---|---|
| #1 | 5 | 0.8 |
| #2 | 2.5 | 1.0 |
| #3 | 0.5 | — |
| #4 | 0.1 | — |

### Example 13: Synthesis of Polymer Spheres with Controlled Diameter in Batch, Variation of the Dialdehyde and the Maleimide

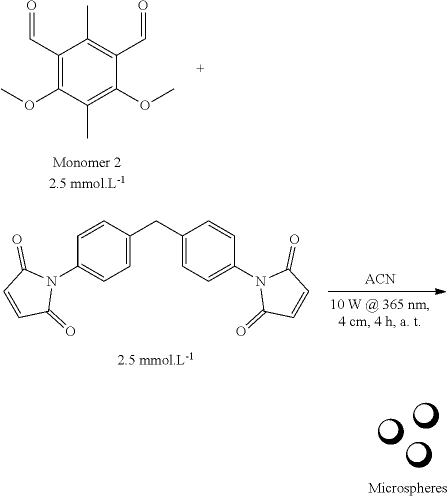

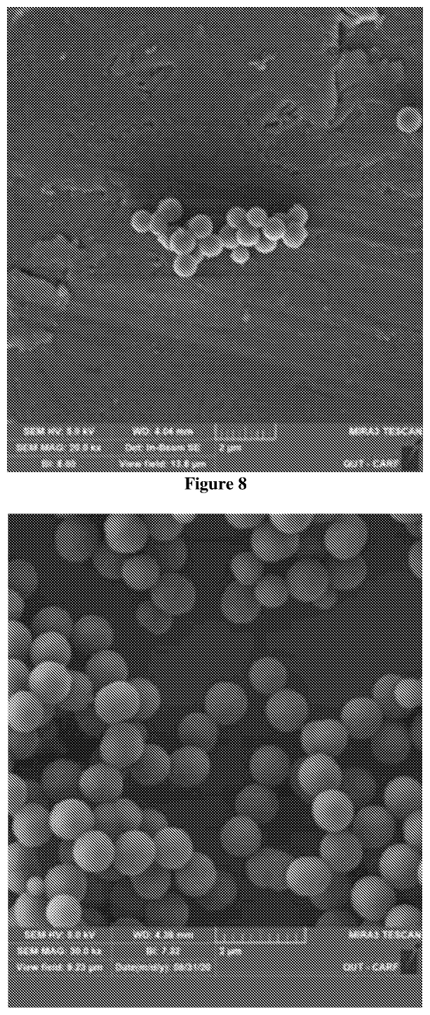

In one non-limiting example, monomer 2 and N,N′-4,4′-diphenylmethane-bis-maleimide were selected as monomers. The monomers were dissolved in acetonitrile (C_{monomer 2}=C_{bis-maleimide}=2.5 mmol L⁻¹ V=2 mL). The solutions were passed through a 2.5 μM PTFE syringe filter and placed in 2 mL individual crimp cap vials. Oxygen was removed by passing through a stream of nitrogen (N₂). Under irradiation with 10 W LED (λₘₐₓ=365 nm, 4 cm distance) on a bottle roller at 10 rpm, the clear solution gradually becomes heterogeneous upon irradiation. After 4 h, the turbid solution was centrifuged, the supernatant was removed and the solid pellet washed with THF. The resulting particles were characterized via SEM (refer to FIG. 8, Dₙ 0.78 [μm])).

### Example 14: Synthesis of Crosslinked Polymer Spheres in Batch

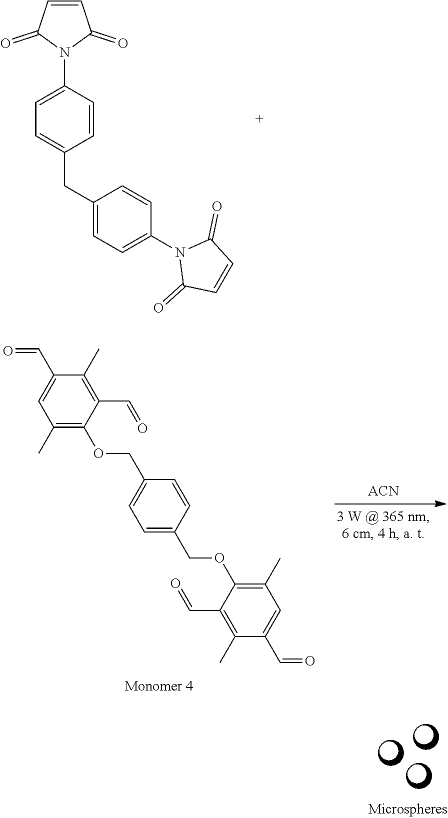 [SMILES: O=C1C=CC(=O)N1c1ccc(Cc2ccc(N3C(=O)C=CC3=O)cc2)cc1 ; Cc1cc(C=O)c(C)c(C=O)c1OCc1ccc(COc2c(C)cc(C=O)c(C)c2C=O)cc1 ; "ACN"]

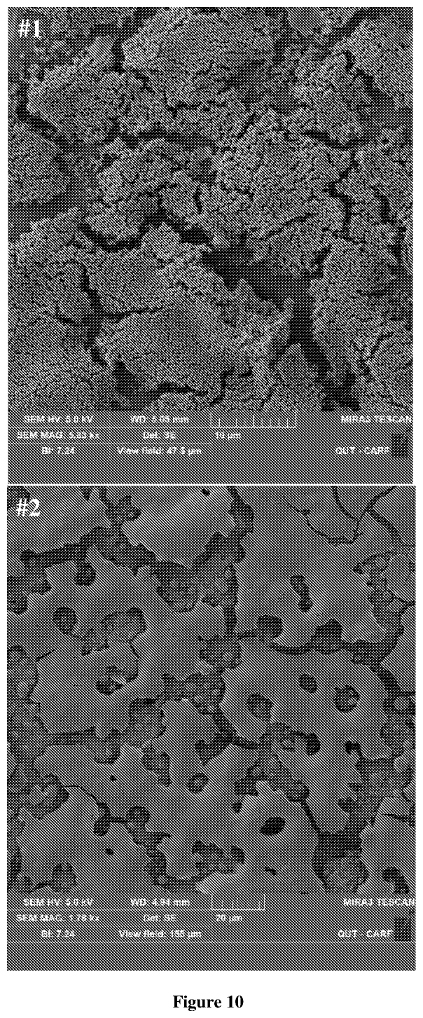

In one non-limiting example, monomer 4 and N,N′-4,4′-diphenylmethane-bis-maleimide were selected as monomers. The monomers were dissolved in toluene/DCM (50:50 v:v) (C_{monomer 4}=C_{bis-maleimide}=5 mmol L⁻¹ V=1.5 mL). The solutions were passed through a 2.5 μM PTFE syringe filter and placed in a 2 mL crimp cap vial. Oxygen was removed by passing through a stream of nitrogen (N₂). Under irradiation with 3 W LED (λₘₐₓ=365 nm, 6 cm distance) on a bottle roller at 2 rpm, the clear solution gradually becomes heterogeneous upon irradiation. After 4 h, the turbid solution was centrifuged, the supernatant was removed and the solid pellet washed with DCM. The resulting particles were characterized via SEM (refer to FIG. 9).

### Example 15: Polymer Spheres with Tunable Backbone

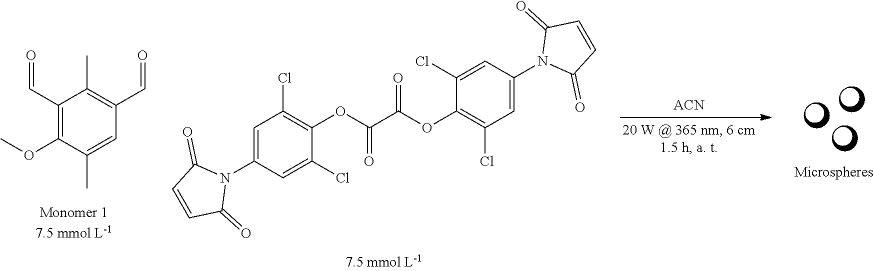 [SMILES: COc1c(C)cc(C=O)c(C)c1C=O ; O=C(Oc1c(Cl)cc(N2C(=O)C=CC2=O)cc1Cl)C(=O)Oc1c(Cl)cc(N2C(=O)C=CC2=O)cc1Cl ; "ACN"]

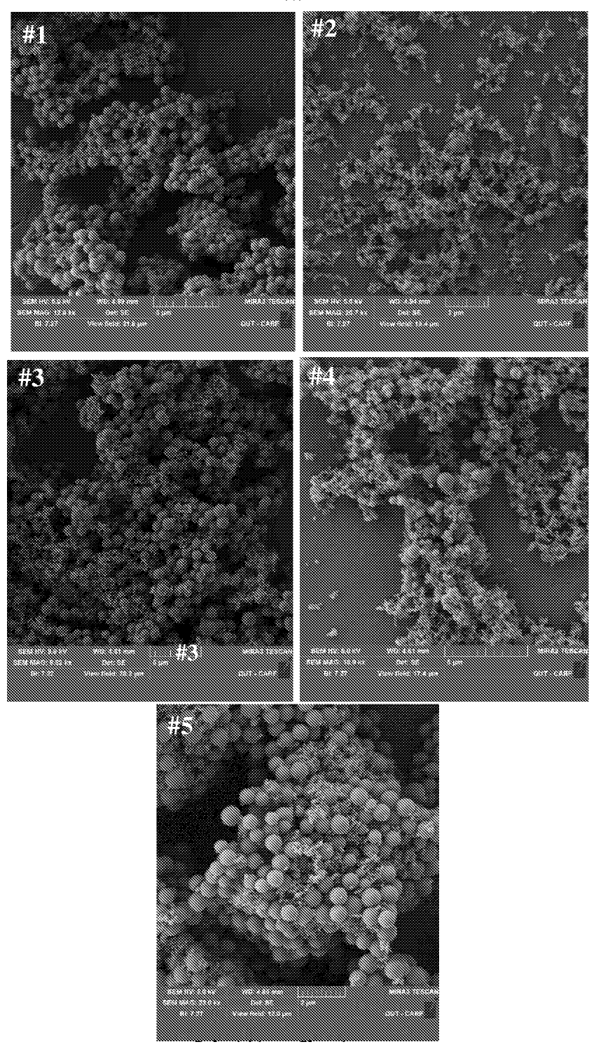

In one non-limiting example, monomer 1 and bis(2,6-dichloro-4-(2,5-dioxo-2,5-dihydro-1H-pyrrol-1-yl)phenyl) oxalate were selected as monomers. The monomers were dissolved in acetonitrile (C_{monomer 1}=C_{bis-maleimide}=5 mmol L⁻¹ V=10 mL). The solution was passed through a 2.5 μM PTFE syringe filter and placed in a 5 mL crimp cap vial. Oxygen was removed by passing through a stream of nitrogen (N₂). Under irradiation with 20 W LED (λₘₐₓ=365 nm, 6 cm distance) on a bottle roller at 10 rpm, the clear solution gradually becomes heterogeneous upon irradiation. After 1.5 h, the turbid solution was centrifuged, the supernatant was removed and the solid pellet washed with DCM. The resulting particles were characterized via SEM (refer to FIG. 10).

General Procedure 2: Particle Synthesis Under Continuous Flow

Microspheres were successfully prepared by photo-induced step-growth Diels-Alder polymerisation in flow. The method of preparing microspheres according to the present invention comprises preparing a homogeneous mixture comprising only the monomer(s) and solvent. Subsequently the solution is filtered, optionally degassed by passing through a stream of nitrogen, pumped through a flow reactor and irradiated with a suitable light source. In a non-limiting setup, LEDs are used as light source and syringe pumps with air-tight syringes are used. The reactor output is collected after equilibration (3 times the retention time).

In one non-limiting example, monomer 1 and N,N′-4,4′-diphenylmethane-bis-maleimide were selected as monomers. The monomers were dissolved in acetonitrile (C_{monomer 1}=C_{bis-maleimide}=7.5 mmol L⁻¹ V=30 mL). The solution was passed through a 2.5 μM PTFE syringe filter and oxygen was removed by passing through a stream of nitrogen (N₂). The solution was pumped through a PFA coil with 1.0 mm bore size and an internal volume of 840 μL with a syringe pump and an air-tight Hamilton@ syringe under irradiation with a 7.5-24 W LED (λₘₐₓ=365 nm, 3 cm distance) and a respective flow-rate (refer to Table 6). The clear solution gradually becomes heterogeneous upon irradiation. After equilibration (three times the reactor inner volume), the turbid reactor output was collected, centrifuged, the supernatant removed and the solid pellet washed with DCM. The resulting particles were characterized via SEM (refer to FIG. 11, 0.75-1.0 Dₙ [μm] and Table 6).

TABLE 6
Microspheres from Example 16

| | Retention Time | Flow rate | P (LED @ 365 nm) | |
|---|---|---|---|---|
| No | [min] | [uL min⁻¹] | [W] | Dₙ [μm] |
| #1 | 20 | 42 | 24 | 0.75 |
| #2 | 40 | 21 | 12 | — |
| #3 | 60 | 14 | 7.5 | 1.0 |
| #4 | 5 | 168 | 24 | — |
| #5 | 30 | 28 | 24 | 0.77 |

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A method of producing polymer particles by precipitation polymerisation, the method comprising:
providing a reaction solution comprising (i) solvent, (ii) a photo-active compound that upon being subjected to a wavelength of light forms two o-quinodimethane structures, and (iii) a multi-dienophile compound;
subjecting the reaction solution to the wavelength of light, which promotes step-growth Diels-Alder polymerisation of the photo-active and multi-dienophile compound;
wherein as a result of the step-growth Diels-Alder polymerisation polymer precipitates from the reaction solution and self-assembles into the polymer particles.

2. The method according to claim 1, wherein the photo-active compound includes a compound of general structure (1): 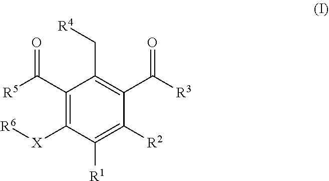
where R¹ is selected from H, halogen, CN, optionally substituted alkoxy, optionally substituted alkylthio, and saturated or unsaturated optionally substituted C₁₋₂₃-alkyl;
R² is selected from H, halogen, CN, optionally substituted alkoxy, optionally substituted alkylthio, and saturated or unsaturated optionally substituted C₁₋₂₃-alkyl;
R³ is selected from H, CN, saturated or unsaturated optionally substituted C₁₋₂₃-alkyl, optionally substituted aryl and optionally substituted heteroaryl;
R⁴ is selected from H, halogen, CN, optionally substituted alkoxy, optionally substituted alkylthio, and saturated or unsaturated optionally substituted C₁₋₂₃-alkyl;
R⁵ is selected from H, CN, saturated or unsaturated optionally substituted C₁₋₂₃-alkyl, optionally substituted aryl and optionally substituted heteroaryl;
R⁶ is selected from saturated or unsaturated optionally substituted C₁₋₂₃-alkyl, optionally substituted aryl, optionally substituted heteroaryl and SiR₃ where R is selected from optionally substituted C₁₋₂₃-alkyl, optionally substituted aryl and heteroaryl; and
X is oxygen or sulphur.

3. The method according to claim 1, wherein the photo-active compound includes a compound of general structure (II): 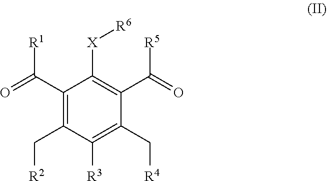
where R¹ is selected from H, saturated or unsaturated optionally substituted C₁₋₂₃-alkyl, optionally substituted aryl and optionally substituted heteroaryl;
R² is selected from H, halogen, CN, optionally substituted alkoxy, optionally substituted alkylthio, and saturated or unsaturated optionally substituted C₁₋₂₃-alkyl;
R³ is selected from H, halogen, CN, optionally substituted alkoxy, optionally substituted alkylthio, and saturated or unsaturated optionally substituted C₁₋₂₃-alkyl;
R⁴ is selected from H, halogen, CN, optionally substituted alkoxy, optionally substituted alkylthio, and saturated or unsaturated optionally substituted C₁₋₂₃-alkyl;
R⁵ is selected from H, saturated or unsaturated optionally substituted C₁₋₂₃-alkyl, optionally substituted aryl and optionally substituted heteroaryl;
R⁶ is selected from saturated or unsaturated optionally substituted C₁₋₂₃-alkyl, optionally substituted aryl, optionally substituted heteroaryl and SiR₃ where R is selected from optionally substituted C₁₋₂₃-alkyl, optionally substituted aryl and heteroaryl; and
X is oxygen or sulphur.

4. The method according to claim 1, wherein the photo-active compound includes a compound of general structure (III): 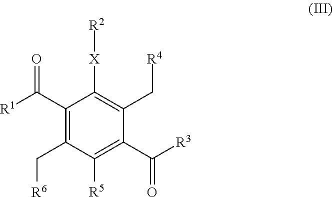
where R¹ is selected from H, CN, saturated or unsaturated optionally substituted C₁₋₂₃-alkyl, optionally substituted aryl and optionally substituted heteroaryl;
R² is selected from saturated or unsaturated optionally substituted C₁₋₂₃-alkyl, optionally substituted aryl, optionally substituted heteroaryl and SiR₃ where R is selected from optionally substituted C₁₋₂₃-alkyl, optionally substituted aryl and heteroaryl;
R³ is selected from H, CN, saturated or unsaturated optionally substituted C₁₋₂₃-alkyl, optionally substituted aryl and optionally substituted heteroaryl;
R⁴ is selected from H, halogen, CN, optionally substituted alkoxy, optionally substituted alkylthio, and saturated or unsaturated optionally substituted C₁₋₂₃-alkyl;
R⁵ is selected from H, halogen, CN, optionally substituted alkoxy, optionally substituted alkylthio, and saturated or unsaturated optionally substituted C₁₋₂₃-alkyl;
R⁶ is selected from H, halogen, CN, optionally substituted alkoxy, optionally substituted alkylthio, and saturated or unsaturated optionally substituted C₁₋₂₃-alkyl; and
X is oxygen or sulphur.

5. The method according to claim 1, wherein the multi-dienophile compound is selected from bis-maleimides, tris-maleimides, tetrakis-maleimides, pentakis-maleimides and combinations thereof.

6. The method according to claim 1, wherein the solvent is a polar aprotic solvent.

7. The method according to claim 1, wherein the polymer particles produced comprise substantially spherical polymer microparticles.

8. The method according to claim 1, wherein the polymer particles produced comprise substantially spherical polymer nanoparticles.

9. The method according to claim 1, wherein the photo-active compound includes a compound of general structure (IV): 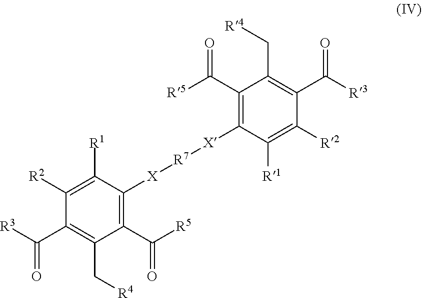
where R¹ and R^{′1} are each independently selected from H, halogen, CN, optionally substituted alkoxy, optionally substituted alkylthio, and saturated or unsaturated optionally substituted C₁₋₂₃-alkyl;
R² and R^{′2} are each independently selected from H, halogen, CN, optionally substituted alkoxy, optionally substituted alkylthio, and saturated or unsaturated optionally substituted C₁₋₂₃-alkyl;
R³ and R^{′3} are each independently selected from H, saturated or unsaturated optionally substituted C₁₋₂₃-alkyl, optionally substituted aryl and optionally substituted heteroaryl;
R⁴ and R^{′4} are each independently selected from H, halogen, CN, optionally substituted alkoxy, optionally substituted alkylthio, and saturated or unsaturated optionally substituted C₁₋₂₃-alkyl;
R⁵ and R^{′s} are each independently selected from H, saturated or unsaturated optionally substituted C₁₋₂₃-alkyl, optionally substituted aryl and optionally substituted heteroaryl;
R⁷ is selected from saturated or unsaturated optionally substituted C₁₋₂₃-alkyl, optionally substituted aryl, optionally substituted heteroaryl and SiR₂ where R is selected from optionally substituted C₁₋₂₃-alkyl, optionally substituted aryl and heteroaryl; and
X and X are each independently oxygen or sulphur.

10. The method according to claim 1, wherein the photo-active compound includes a compound of general structure (V): 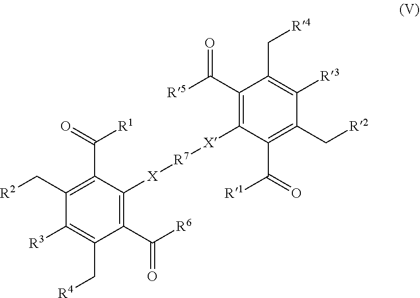
where R¹ and R^{′1} are each independently selected from H, saturated or unsaturated optionally substituted C₁₋₂₃-alkyl, optionally substituted aryl and optionally substituted heteroaryl;
R² and R^{′2} are each independently selected from H, halogen, CN, optionally substituted alkoxy, optionally substituted alkylthio, and saturated or unsaturated optionally substituted C₁₋₂₃-alkyl;
R³ and R^{′3} are each independently selected from H, halogen, CN, optionally substituted alkoxy, optionally substituted alkylthio, and saturated or unsaturated optionally substituted C₁₋₂₃-alkyl;
R⁴ and R^{′4} are each independently selected from H, halogen, CN, optionally substituted alkoxy, optionally substituted alkylthio, and saturated or unsaturated optionally substituted C₁₋₂₃-alkyl;
R⁵ and R^{′5} are each independently selected from H, saturated or unsaturated optionally substituted C₁₋₂₃-alkyl, optionally substituted aryl and optionally substituted heteroaryl;
R⁷ is selected from saturated or unsaturated, optionally substituted C₁₋₂₃-alkyl, optionally substituted aryl, optionally substituted heteroaryl and SiR₂ where R is selected from optionally substituted C₁₋₂₃-alkyl, optionally substituted aryl and heteroaryl; and
X and X′ are each independently oxygen or sulphur.

11. The method according to claim 1, wherein the multi-dienophile compound is selected from those of general structures (VI), (VII) and (VIII): 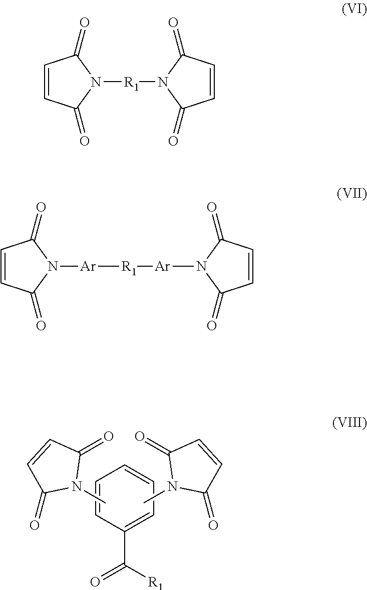
where for general structure (VI) R₁ is selected from optionally substituted aryl, optionally substituted alkyl and optionally substituted carbocyclyl; for general structure (VII) R₁ is selected from optionally substituted aryl, optionally substituted alkyl and optionally substituted carbocyclyl, and each Ar is independently optionally substituted aryl or heteroaryl, and for general structure (VIII) R₁ is selected from optionally substituted aryl, optionally substituted alkyl, optionally substituted carbocyclyl, and a linking group that couples one or more compounds of structure (VIII) through the R₁ substituent to structure (VIII), where the linking group is selected from optionally substituted aryl, optionally substituted alkyl and optionally substituted carbocyclyl.

12. The method according to claim 1, wherein the multi-dienophile compound is selected from N,N′-m/o/p-phenylene-bis-maleimide, N,N′-hexamethylene-bis-maleimide, N,N′-octamethylene-bis-maleimide, N,N′-4,4′-diphenylmethane-bis-maleimide, N,N′-ethylene-bis-maleimide, N,N′-butylene-bis-maleimide, N,N′-4, 4′-diphenyl ether bis-maleimide: N,N′-4,4′diphenyl sulfone-bis-maleimide, N,N′-4,4′-dicyclohexyl methane-bis-maleimide, N,N′-xylylene-bis-maleimide, N,N′-diphenyl cyclohexane-bis-male imide, N,N′-(p-tolylene) bismaleimide, N,N′-(methylenedi-p-phenylene)-bismaleimide, N,N′-(oxydi-p-phenylene)bismaleimide, α,α-bis-(4-phenylene)-bismaleimide, N,N′-(m-xylylene) bis-citraconimide, α,α-bis-(4-maleimidophenyl)-meta-di isopropylbenzene, 2,4-bismaleimidotoluene, 4,4′-bis(o-propenylphenoxy)-benzophenone, 2,2′-bis(3-allyl-4-hydroxyphenyl)-propane and combinations thereof.

13. The method according to claim 1, wherein the photoactive compound and the multi-dienophile compound are present in a mole ratio of from about 0.1:1 to about 10:1.

14. The method according to claim 1, wherein they polymer particles are produced in a flow reactor.

15. The method according to claim 1, wherein the reaction solution does not comprise an emulsifier or surfactant.

16. Polymer particles comprising Diels-Alder polymerised residues of (i) a photo-active compound that upon being subjected to a wavelength of light forms two o-quinodimethane structures and (ii) a multi-dienophile compound.

17. The polymer particles according to claim 16, wherein the photo-active compound includes a compound of general structure (1): 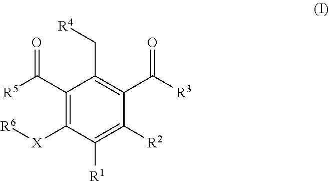
where R¹ is selected from H, halogen, CN, optionally substituted alkoxy, optionally substituted alkylthio, and saturated or unsaturated optionally substituted C₁₋₂₃-alkyl;
R² is selected from H, halogen, CN, optionally substituted alkoxy, optionally substituted alkylthio, and saturated or unsaturated optionally substituted C₁₋₂₃-alkyl;
R³ is selected from H, saturated or unsaturated optionally substituted C₁₋₂₃-alkyl, optionally substituted aryl and optionally substituted heteroaryl;
R⁴ is selected from H, halogen, CN, optionally substituted alkoxy, optionally substituted alkylthio, and saturated or unsaturated optionally substituted C₁₋₂₃-alkyl;
R⁵ is selected from H, saturated or unsaturated optionally substituted C₁₋₂₃-alkyl, optionally substituted aryl and optionally substituted heteroaryl;
R⁶ is selected from saturated or unsaturated optionally substituted C₁₋₂₃-alkyl, optionally substituted aryl, optionally substituted heteroaryl and SiR₃ where R is selected from optionally substituted C₁₋₂₃-alkyl, optionally substituted aryl and heteroaryl; and
X is oxygen or sulphur.

18. The polymer particles according to claim 16, wherein the photo-active compound includes a compound of general structure (II): 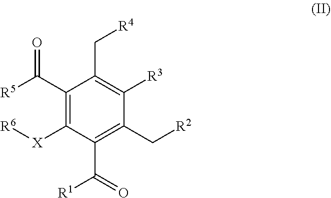
where R¹ is selected from H, CN, saturated or unsaturated optionally substituted C₁₋₂₃-alkyl, optionally substituted aryl and optionally substituted heteroaryl;
R² is selected from H, halogen, CN, optionally substituted alkoxy, optionally substituted alkylthio, and saturated or unsaturated optionally substituted C₁₋₂₃-alkyl;
R³ is selected from H, halogen, CN, optionally substituted alkoxy, optionally substituted alkylthio, and saturated or unsaturated optionally substituted C₁₋₂₃-alkyl;
R⁴ is selected from H, halogen, CN, optionally substituted alkoxy, optionally substituted alkylthio, and saturated or unsaturated optionally substituted C₁₋₂₃-alkyl;
R⁵ is selected from H, CN, saturated or unsaturated optionally substituted C₁₋₂₃-alkyl, optionally substituted aryl and optionally substituted heteroaryl;
R⁶ is selected from saturated or unsaturated, optionally substituted C₁₋₂₃-alkyl, optionally substituted aryl, optionally substituted heteroaryl and SiR₃ where R is selected from optionally substituted C₁₋₂₃-alkyl, optionally substituted aryl and heteroaryl; and
X is oxygen or sulphur

19. The polymer particles according to claim 16, wherein the photo-active compound includes a compound of general structure (Ill): 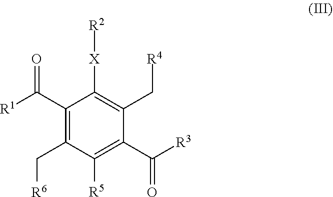
where R¹ is selected from H, CN, saturated or unsaturated optionally substituted C₁₋₂₃-alkyl, optionally substituted aryl and optionally substituted heteroaryl;
R² is selected from saturated or unsaturated, optionally substituted C₁₋₂₃-alkyl, optionally substituted aryl, optionally substituted heteroaryl SiR₃ where R is selected from optionally substituted C₁₋₂₃-alkyl, optionally substituted aryl, heteroaryl;
R³ is selected from H, CN, saturated or unsaturated optionally substituted C₁₋₂₃-alkyl, optionally substituted aryl and optionally substituted heteroaryl;
R⁴ is selected from H, halogen, CN, optionally substituted alkoxy, optionally substituted alkylthio, and saturated or unsaturated optionally substituted C₁₋₂₃-alkyl;
R⁵ is selected from H, halogen, CN, optionally substituted alkoxy, optionally substituted alkylthio, and saturated or unsaturated optionally substituted C₁₋₂₃-alkyl;
R⁶ is selected from H, halogen, CN, optionally substituted alkoxy, optionally substituted alkylthio, and saturated or unsaturated optionally substituted C₁₋₂₃-alkyl; and
X is oxygen or sulphur.
